(19) United States
(12) Patent Application Publication
(10) Pub. No.: US 2020/0176748 A1
(43) Pub. Date: Jun. 4, 2020

(54) BATTERY, BATTERY MODULE, BATTERY PACK, VEHICLE, ELECTRICITY STORAGE SYSTEM, ELECTRIC TOOL AND ELECTRONIC DEVICE

(71) Applicant: MURATA MANUFACTURING CO., LTD., Kyoto (JP)

(72) Inventors: Natsuko KATASE, Kyoto (JP); Nobuyuki IWANE, Kyoto (JP); Yoshinori WAKUI, Kyoto (JP); Takahisa ISHIMATSU, Kyoto (JP); Masato YANO, Kyoto (JP)

(21) Appl. No.: 16/733,665

(22) Filed: Jan. 3, 2020

Related U.S. Application Data
(63) Continuation of application No. PCT/JP2018/024573, filed on Jun. 28, 2018.

(30) Foreign Application Priority Data
Jul. 5, 2017 (JP) 2017-132123

(51) Int. Cl. H01M 2/22; H01M 2/06; H01M 2/10; H01M 10/42; H01M 2/02

(52) U.S. Cl. CPC H01M 2/22; H01M 2/06; H01M 2/1022; H01M 2010/4271; H01M 10/425; H01M 2/0287; H01M 2/1077

(57) ABSTRACT

It is an object to provide a battery and a battery module having excellent reliability.

There is provided a battery including a battery element, an exterior body that covers the battery element, and a conductor, in which the conductor is disposed outside the battery element, and the conductor has a cut portion, and there is further provided a battery module including a plurality of batteries and a conductor, in which each of the batteries includes a battery element and an exterior body that covers the battery element, the conductor is disposed outside the battery element, and the conductor has a cut portion.

### TECHNICAL FIELD

The present technology relates to a battery and a battery module, and more particularly to a battery, a battery module, a battery pack, a vehicle, a power storage system, a power tool, and an electronic device.

### BACKGROUND ART

In recent years, demand for batteries and battery modules has been rapidly expanding in technical fields of electronic devices such as personal computers (PCs) and mobile communication terminals, automobiles such as electric vehicles, and new energy systems such as wind power generation, and the like.

For example, there has been proposed a battery characterized by including a wound body that includes a laminated structure of a positive electrode and a negative electrode, each having an active material layer selectively formed on a current collector, and a separator positioned between the positive electrode and the negative electrode, in which at an outer peripheral side end of the wound body, exposed regions other than covered regions covered with the active material layer among the respective current collectors in the positive electrode and the negative electrode oppose each other with the separator interposed therebetween, and an exposed region in at least one of the current collectors of the positive electrode and the negative electrode has a particulate protrusion, and has a surface roughness of 2.0 μm or more and 10.0 μm or less in terms of Rz value (see Patent Document 1).

Further, for example, there has been proposed a secondary battery characterized in that, outside a battery can that constitutes either a positive electrode terminal or a negative electrode terminal of the battery, a conductive base material is disposed in a state of being insulated with a non-conductive film interposed therebetween, in which the conductive base material is electrically connected to an electrode terminal in reverse polarity to the battery can (see Patent Document 2).

Furthermore, for example, there has been proposed a non-aqueous electrolyte secondary battery including a positive electrode that includes a positive electrode current collector and a positive electrode active material layer, a negative electrode that includes a negative electrode current collector and a negative electrode active material layer, a separator disposed between the positive electrode active material layer and the negative electrode active material layer, and a metal foil laminated body constituted of a first metal foil having a positive electrode potential, a second metal foil having a negative electrode potential, and an insulator disposed between the positive electrode metal foil and the negative electrode metal foil, in which tensile strength of the insulator is smaller than tensile strength of the separator (see Patent Document 3).

### PRIOR ART DOCUMENTS

### Patent Documents

Patent Document 1: Japanese Patent Application Laid-Open No. 2008-262810

Patent Document 2: Japanese Patent Application Laid-Open No. 2012-69535

Patent Document 3: Japanese Patent Application Laid-Open No. 2008-277201

### SUMMARY OF THE INVENTION

### Problem to be Solved by the Invention

However, the technologies proposed in Patent Documents 1 to 3 may not be capable of further improving reliability. Accordingly, the present situation is that batteries and battery modules having further improved reliability are desired.

Therefore, the present technology has been made in view of such a situation, and a main object thereof is to provide a battery, a battery module, a battery pack, a vehicle, a power storage system, a power tool, and an electronic device having excellent reliability.

### Means for Solving the Problem

As a result of intensive studies in order to solve the above-described object, the present inventors have succeeded in developing a battery and a battery module having excellent reliability, and have completed the present technology.

Specifically, the present technology provides a battery including a battery element, an exterior body that covers the battery element, and a conductor, in which the conductor is disposed outside the battery element, and the conductor has a cut portion.

In the battery according to the present technology, the conductor may be disposed inside the exterior body.

In the battery according to the present technology, the cut portion may penetrate therethrough.

In the battery according to the present technology, the cut portion may not penetrate therethrough.

In the battery according to the present technology, the exterior body may include a laminate material.

Further, the present technology provides a battery module including a plurality of batteries and a conductor, in which each of the batteries includes a battery element and an exterior body that covers the battery element, the conductor is disposed outside the battery element, and the conductor has a cut portion.

In the battery module according to the present technology, the conductor may be disposed outside the exterior body.

In the battery module according to the present technology, the cut portion may penetrate therethrough.

In the battery module according to the present technology, the cut portion may not penetrate therethrough.

In the battery module according to the present technology, the exterior body may include a laminate material.

Furthermore, the present technology

provides a battery pack including the battery according to the present technology,

provides a battery pack including the battery according to the present technology, a control unit that controls a use state of the battery, and a switch unit that switches the use state of the battery according to an instruction from the control unit,

provides a vehicle including the battery according to the present technology, a driving force conversion apparatus that receives supply of electric power from the battery and converts the electric power into a driving force of the vehicle, a driving unit that drives according to the driving force, and a vehicle control device,

provides a power storage system including a power storage device that has the battery according to the present technology, a power consumption apparatus to which electric power is supplied from the battery, a control device that controls power supply from the battery to the power consumption apparatus, and a power generation apparatus that charges the battery,

provides a power tool including the battery according to the present technology, and a movable part to which electric power is supplied from the battery, and

provides an electronic device including the battery according to the present technology, in which the electronic device receives supply of electric power from the battery.

Furthermore, the present technology

provides a vehicle including the battery module according to the present technology, a driving force conversion apparatus that receives supply of electric power from the battery module and converts the electric power into a driving force of the vehicle, a driving unit that drives according to the driving force, and a vehicle control device,

provides a power storage system including a power storage device that has the battery module according to the present technology, a power consumption apparatus to which electric power is supplied from the battery module, a control device that controls power supply from the battery module to the power consumption apparatus, and a power generation apparatus that charges the battery module, and

provides an electronic device including the battery module according to the present technology, in which the electronic device receives supply of electric power from the battery module.

### Advantageous Effect of the Invention

According to the present technology, reliability of a battery can be improved. Note that the effects described here are not necessarily limited, and may be any of the effects described in the present disclosure or effects different therefrom.

### BRIEF EXPLANATION OF DRAWINGS

FIG. 1 is an exploded perspective view illustrating a configuration example of a battery of a first embodiment according to the present technology.

FIG. 2 are views illustrating examples of a shape of a cut portion included in a conductor provided in the battery of the first embodiment and a battery module of a second embodiment according to the present technology.

FIG. 3 is an exploded perspective view illustrating a configuration example of the battery module of the second embodiment according to the present technology.

FIG. 4 are cross-sectional views for describing a result of Example 1 according to the present technology.

FIG. 5 is an enlarged cross-sectional view of FIG. 2 for explaining a result of Example 1 according to the present technology.

FIG. 6 are views for explaining a result of Comparative Example 1 according to the present technology.

FIG. 7 is a block diagram illustrating a configuration of an application example (battery pack) of the battery according to the present technology.

FIG. 8 is a block diagram illustrating a configuration of an application example (vehicle) of the battery and the battery module according to the present technology.

FIG. 9 is a block diagram illustrating a configuration of an application example (power storage system) of the battery and the battery module according to the present technology.

FIG. 10 is a block diagram illustrating a configuration of an application example (power tool) of the battery according to the present technology.

FIG. 11 is a block diagram illustrating a configuration of an application example (electronic device) of the battery and the battery module according to the present technology.

FIG. 12 is a diagram illustrating a configuration of Application Example 1 (printed circuit board) of the battery and the battery module according to the present technology.

FIG. 13 is a view illustrating an example of a configuration of Application Example 2 (universal credit card) of the battery and the battery module according to the present technology.

FIG. 14 is a view illustrating an example of a configuration of Application Example 3 (wristband type activity meter) of the battery and the battery module according to the present technology.

FIG. 15 is a view illustrating an example of a configuration of Application Example 3 (wristband type activity meter) of the battery and the battery module according to the present technology.

FIG. 16 is a view illustrating a configuration of Application Example 3 (wristband type electronic device) of the battery and the battery module according to the present technology.

FIG. 17 is an exploded perspective view illustrating a configuration of Application Example 4 (smart watch) of the battery and the battery module according to the present technology.

FIG. 18 is a view illustrating a part of an internal configuration of Application Example 4 (band type electronic device) of the battery and the battery module according to the present technology.

FIG. 19 is a block diagram illustrating a circuit configuration of Application Example 4 (band type electronic device) of the battery and the battery module according to the present technology.

FIG. 20 is a view illustrating a specific example of a configuration of Application Example 5 (glasses type terminal) of the battery and the battery module according to the present technology.

### MODE FOR CARRYING OUT THE INVENTION

Hereinafter, preferred embodiments for carrying out the present technology will be described with reference to the drawings. The embodiments described below present examples of typical embodiments of the present technology, and will not cause the scope of the present technology to be interpreted narrowly. Note that about drawings, the same symbols are attached to the same or equivalent elements or members, and overlapping descriptions will be omitted.

Note that the description will be made in the following order.

1. Overview of the present technology

2. First embodiment (battery example)

3. Second embodiment (battery module example)

4. Applications of battery and battery module

4-1. Overview of applications of battery and battery module

4-2. Third embodiment (battery pack example)

4-3. Fourth embodiment (vehicle example)

4-4. Fifth embodiment (power storage system example)

4-5. Sixth embodiment (power tool example)

4-6. Seventh embodiment (electronic device example)

### 1. Overview of the Present Technology

First, an overview of the present technology will be described.

There are various technologies for safety measures in cases where a battery receives external force. For example, there is a technology such that at an outer peripheral side end of a wound body, an exposed region of a current collector in a positive electrode and an exposed region of a current collector in a negative electrode oppose each other with a separator interposed therebetween, and a particulate protrusion is provided in at least one of these exposed regions, in which when the wound body is deformed by an excessive external force, the exposed areas of the positive electrode and the negative electrode are quickly brought into contact with each other to reliably generate a short circuit. According to this technology, it is possible to manufacture a battery in which a protrusion is provided on a current collector foil. However, in this technology, in order to produce an electrode after providing the protrusion on the current collector foil, it is necessary to add limiting conditions to the method for producing the electrode, and if the limiting conditions are not added, the protrusion may deteriorate wettability, and in the worst case it may be impossible to produce the electrode.

Further, for example, there is a technology related to a secondary battery having improved safety, characterized in that, outside a battery can that constitutes either a positive electrode terminal or a negative electrode terminal of the battery, a conductive base material is disposed in a state of being insulated with a non-conductive film interposed therebetween, in which the conductive base material is electrically connected to an electrode terminal in reverse polarity to the battery can. This technology enables to manufacture a battery in which the electrode terminal in reverse polarity and the conductive base material are disposed in a state of being insulated from the battery can that constitutes the positive electrode terminal or the negative electrode terminal of the battery, with the non-conductive film interposed therebetween. However, in this technology, in order for the battery can and conductive equipment to be electrically connected with the non-conductive film interposed therebetween, a conductor penetrating from the outside is necessary, and there is a possibility that the battery does not operate by a damage of the cell due to deformation.

Furthermore, for example, there is a technology related to a non-aqueous electrolyte secondary battery structured such that a separator that separates a positive electrode and a negative electrode has a shutdown film and a heat-resistant porous film, in which at least an outermost periphery of the positive electrode and the negative electrode has an exposed portion to which no active material is applied, and a positive electrode current collector exposed portion and a negative electrode current collector exposed portion oppose each other with the shutdown film interposed therebetween and with the heat-resistant porous film not interposed therebetween, thereby suppressing heat generation and thermal runaway. This technology enables to manufacture a battery structured such that a separator that separates a positive electrode and a negative electrode has a shutdown film and a heat-resistant porous film, in which at least an outermost periphery of the positive electrode and the negative electrode has an exposed portion to which no active material is applied, and a positive electrode current collector exposed portion and a negative electrode current collector exposed portion oppose each other with only the shutdown film therebetween. However, in this technology, the separator having the shutdown film and the heat-resistant porous film should be used, and unless using this separator, it is possible that heat generation and thermal runaway cannot be suppressed.

The present technology is based on the above situation, and according to the present technology, reliability of a battery and a battery module including a plurality of batteries can be improved and maintained. That is, according to the present technology, a battery or a battery module can be provided that is safely damaged when the battery element or the battery is deformed and broken by an external force, by including a conductor that has a cut portion on an outside of a battery element, and by that the cut portion included in the conductor comes in contact with a broken cross section of the battery element and quickly causes a short circuit on a surface layer portion of the battery element.

A battery according to the present technology and a plurality of batteries included in the battery module are not particularly limited in the shape of the battery, the type of an exterior body, the type of an electrode reactant, and so on and are, for example, cylindrical type, square type, or laminate film type lithium ion secondary batteries, and in the present technology, the laminate film type lithium ion secondary battery is preferable. The battery and the battery module according to the present technology can be suitably applied to a battery pack, a vehicle, a power storage system, a power tool, an electronic device, and the like.

### 2. First Embodiment (Example of Battery)

A battery of a first embodiment (battery example) according to the present technology includes a battery element, an exterior body that covers the battery element, and a conductor, in which the conductor is disposed outside the battery element, and the conductor is a battery having a cut portion.

The battery of the first embodiment according to the present technology can achieve a battery having a safety mechanism that is not limited by an electrode producing process and a member used by the battery cell, and operates even when the battery cell is deformed and damaged when being subjected to unexpected pressure from the outside. That is, by using the battery of the first embodiment according to the present technology, when the battery is deformed and broken by an external force without affecting characteristics of the battery, the conductive cut portion comes in contact with a broken cross section of the battery element and quickly causes a short circuit on a surface layer portion of the battery element, thereby allowing the battery to be safely damaged.

Therefore, the battery of the first embodiment according to the present technology can improve safety and achieve an excellent reliability effect.

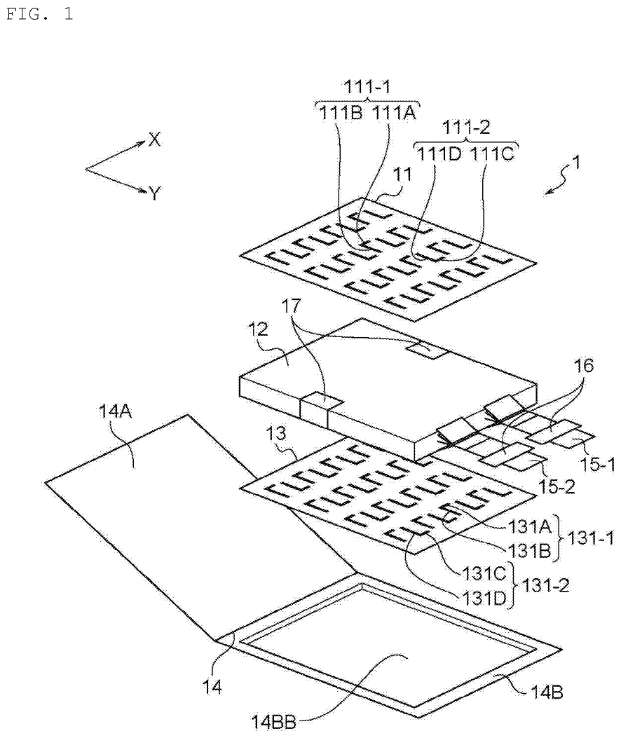

Hereinafter, the battery of the first embodiment (example of battery) according to the present technology will be described in more detail with reference to FIG. 1. FIG. 1 is an exploded perspective view illustrating a configuration example of the battery of the first embodiment according to the present technology.

A battery 1 illustrated in FIG. 1 is, for example, a laminate film type lithium ion secondary battery. The battery 1 includes a battery element 12, an exterior body 14 that covers the battery element 12, and two conductors 11 and 13. Then, each of the conductors 11 and 13 is disposed outside the battery element 12 and disposed inside the exterior body 14. That is, the conductor 11 is disposed between the battery element 12 and an upper surface portion 14A of the exterior body. The conductor 13 is disposed between the battery element 12 and a lower surface portion 14B of the exterior body. Further, as illustrated in FIG. 1, the conductor 13 is accommodated in a recess 14BB of the lower surface portion 14B of the exterior body. An outermost peripheral portion of the battery element 12 is fixed by a fixing member 17 made of a protective tape or the like. Further, although not illustrated in FIG. 1, at least one of the conductor 11 or the conductor 13 may be disposed so as to be wound around the outermost peripheral portion of the battery element 12. In this case, the conductors 11 and 13 are preferably constituted of a material having plasticity (flexibility) so that the conductors 11 and 13 can be wound and bent, for example.

The material of the conductors 11 and 13 may be any material as long as it has conductivity, but is preferably aluminum or stainless steel (SUS). The shape of the conductors 11 and 13 is not particularly limited, and examples thereof include a plate shape, a foil shape, and the like.

At least one of the conductor 11 or the conductor 13 may be electrically connected to a positive electrode tab 15-1 or a negative electrode tab 15-2. Note that it is preferable that at least one of the conductor 11 or the conductor 13 is electrically connected to the positive electrode tab 15-1. As illustrated in FIG. 1, a close-contact film 16 is inserted between the positive electrode tab 15-1 and the negative electrode tab 15-2 and the exterior body 14 in order to prevent intrusion of outside air.

When an external force is applied to the battery 1, the conductors 11 and/or 13 are bent or cut along cut portions 111-1 and/or 111-2 (cut portions of the conductor 11) and/or 131-1 and/or 131-2 (cut portions of the conductor 13), and any one of the above cut portions covers over a cross section of the battery element 12 damaged by the external force, thereby causing a short circuit and ensuring safety.

The conductor 11 has cut portions 111-1 and cut portions 111-2.

The cut portions 111-1 and/or the cut portions 111-2 may be disposed at regular intervals or may be disposed at irregular intervals in the conductor 11.

In FIG. 1, in the conductor 11, cut portions 111-1 and cut portions 111-2 are alternately disposed at regular intervals in an X-axis direction in FIG. 1, and a plurality of cut portions 111-1 and a plurality of cut portions 111-2 that form a row in a Y-axis direction are alternately disposed at regular intervals. Note that a mutual distance between a cut portion 111-1 and a cut portion 111-2 adjacent in the X-axis direction may be arbitrary, and a mutual distance between a plurality of cut portions 111-1 that form a row in the Y-axis direction and a plurality of cut portions 111-2 that form a row in the Y-axis direction may be arbitrary. The cut portions 111-1 and the cut portions 111-2 may be disposed over the entire conductor 11 as illustrated in FIG. 1 or may be disposed in a part of the conductor 11.

A cut portion 111-1 is constituted of two straight portions 111A and 111B, and the straight portion 111B extends from an end of the straight portion 111A in a direction substantially perpendicular to the straight portion 111A. That is, the straight portion 111B extends from the end of the straight portion 111A in the Y-axis direction (a longitudinal direction of the conductor 11) in FIG. 1, while the straight portion 111A extends from an end of the straight portion 111B in the X-axis direction (a transverse direction of the conductor 11) in FIG. 1. The cut portion 111-1 has what is called a bent shape and an L-shape. When the battery 1 is damaged by an external force, the cut portion 111-1 is bent along the two straight portions 111A and 111B and covers over a broken cross section of the battery element 12, causing a short-circuit. Note that in FIG. 1, the straight portion 111B extends from the end of the straight portion 111A in the direction substantially perpendicular to the straight portion 111A, but does not have to extend in the substantially perpendicular direction and may extend, for example, in an acute angle direction or an obtuse angle direction.

The cut portion 111-1 may penetrate or may not penetrate therethrough. That is, both the straight portion 111A and the straight portion 111B constituting the cut portion 111-1 may penetrate or may not penetrate therethrough, or the straight portion 111A may penetrate therethrough and the straight portion 111B may not penetrate therethrough, or the straight portion 111A may not penetrate therethrough and the straight portion 111B may penetrate therethrough. When not penetrating therethrough, it is sufficient if a thickness of the cut portion 111-1 (the straight portions 111A and/or 111B) (in FIG. 1, a thickness in a direction substantially perpendicular to the X-axis direction and the Y-axis direction) is thinner than a thickness in a peripheral region of the cut portion 111-1 (a thickness of the conductor 11 itself) (in FIG. 1, the thickness in the direction substantially perpendicular to the X-axis direction and the Y-axis direction).

Lengths of the straight portions 111A and 111B are not particularly limited, but are preferably approximately lengths such that when the battery 1 is damaged by an external force, the cut portion 111-1 surely bends along two straight portions 111A and 111B in order to ensure a short circuit and secure safety. For example, the lengths of the straight portions 111A and/or 111B are such that when a direction of a broken cross section of the battery element 12 is a direction substantially perpendicular to the X-axis direction and the Y-axis direction (XY plane) in FIG. 1, the lengths may be approximately the same as a thickness of the battery element 12 (in FIG. 1, the thickness in the direction substantially perpendicular to the X-axis direction and the Y-axis direction (XY plane)), or when the direction of the broken cross section of the battery element 12 is approximately 45 degrees oblique from a perpendicular line to the X-axis direction and the Y-axis direction (XY plane) in FIG. 1, the lengths may be approximately a value obtained by multiplying the thickness of the battery element 12 by root 2 (√2), or when the direction of the broken cross section of the battery element 12 is approximately 60 degrees oblique from the perpendicular direction to the X-axis direction and the Y-axis direction (XY plane) in FIG. 1, the lengths may be approximately twice the thickness of the battery element 12. That is, the length of the straight portion 111B is preferably equal to or more than the thickness of the battery element 12 and equal to or less than twice the thickness of the battery element 12.

The straight portions 111A and 111B may have different lengths from each other or may have the same lengths as each other. As illustrated in FIG. 1, the length of the straight portion 111B that is substantially parallel to the longitudinal direction of the conductor 11 (the Y-axis direction in FIG. 1) is preferably larger than the length of the straight portion 111A that is substantially parallel to the transverse direction of the conductor 11 (the X-axis direction in FIG. 1). This is because this preferred mode can ensure a short circuit and improve safety.

In FIG. 1, although the straight portion 111A is disposed substantially parallel to the transverse direction of the conductor 11 (in the X-axis direction in FIG. 1 from the end of the straight portion 111B) and the straight portion 111B is disposed substantially parallel to the longitudinal direction of the conductor 11 (in the Y-axis direction in FIG. 1 from the end of the straight portion 111A), the straight portion 111A may be disposed oblique to the transverse direction of the conductor 11 (in the X-axis direction in FIG. 1 from the end of the straight portion 111B), and the straight portion 111B may be disposed oblique to the longitudinal direction of the conductor 11 (in the Y-axis direction in FIG. 1 from the end of the straight portion 111A).

A cut portion 111-2 is constituted of two straight portions 111C and 111D, and the straight portion 111D extends from an end of the straight portion 111C in a direction substantially perpendicular to the straight portion 111C. That is, the straight portion 111D extends from the end of the straight portion 111C in a direction opposite to the Y-axis direction (the longitudinal direction of the conductor 11) in FIG. 1, while the straight portion 111C extends from an end of the straight portion 111D in the X-axis direction (the transverse direction of the conductor 11) in FIG. 1. The cut portion 111-2 has what is called a bent shape and an L-shape. When the battery 1 is damaged by an external force, the cut portion 111-2 is bent along the two straight portions 111C and 111D and covers over a broken cross section of the battery element 12, causing a short-circuit. Note that in FIG. 1, the straight portion 111D extends from the end of the straight portion 111C in a direction substantially perpendicular to the straight portion 111C, but does not have to extend in the substantially perpendicular direction and may extend in an acute angle direction or an obtuse angle direction.

The cut portion 111-2 may penetrate or may not penetrate therethrough. That is, both the straight portion 111C and the straight portion 111D constituting the cut portion 111-2 may penetrate or may not penetrate therethrough, or the straight portion 111C may penetrate therethrough and the straight portion 111D may not penetrate therethrough, or the straight portion 111C may not penetrate therethrough and the straight portion 111D may penetrate therethrough. When not penetrating therethrough, it is sufficient if a thickness of the cut portion 111-2 (the straight portions 111C and/or 111D) (in FIG. 1, a thickness in the direction substantially perpendicular to the X-axis direction and the Y-axis direction) is thinner than a thickness in a peripheral region of the cut portion 111-2 (a thickness of the conductor 11 itself) (in FIG. 1, the thickness in the direction substantially perpendicular to the X-axis direction and the Y-axis direction).

Lengths of the straight portions 111C and 111D are not particularly limited, but are preferably approximately lengths such that when the battery 1 is damaged by an external force, the cut portion 111-2 surely bends along two straight portions 111C and 111D in order to ensure a short circuit and secure safety. For example, the lengths of the straight portions 111C and/or 111D are such that when the direction of the broken cross section of the battery element 12 is a direction substantially perpendicular to the X-axis direction and the Y-axis direction (XY plane) in FIG. 1, the lengths may be approximately the same as the thickness of the battery element 12 (in FIG. 1, the thickness in the direction substantially perpendicular to the X-axis direction and the Y-axis direction (XY plane)), or when the direction of the broken cross section of the battery element 12 is approximately 45 degrees oblique from a perpendicular line to the X-axis direction and the Y-axis direction (XY plane) in FIG. 1, the lengths may be approximately a value obtained by multiplying the thickness of the battery element 12 by root 2 (√2), or when the direction of the broken cross section of the battery element 12 is approximately 60 degrees oblique from the perpendicular direction to the X-axis direction and the Y-axis direction (XY plane) in FIG. 1, the lengths may be approximately twice the thickness of the battery element 12. That is, the length of the straight portion 111D is preferably equal to or more than the thickness of the battery element 12 and equal to or less than twice the thickness of the battery element 12.

The straight portions 111C and 111D may have different lengths from each other or may have the same lengths as each other. As illustrated in FIG. 1, the length of the straight portion 111D that is substantially parallel to the longitudinal direction of the conductor 11 (the Y-axis direction in FIG. 1) is preferably larger than the length of the straight portion 111C that is substantially parallel to the transverse direction of the conductor 11 (the X-axis direction in FIG. 1). This is because this preferred mode can ensure a short circuit and improve safety.

In FIG. 1, although the straight portion 111C is disposed substantially parallel to the transverse direction of the conductor 11 (in the X-axis direction in FIG. 1 from the end of the straight portion 111D) and the straight portion 111D is disposed substantially parallel to the longitudinal direction of the conductor 11 (in the Y-axis direction in FIG. 1 from the end of the straight portion 111C), the straight portion 111C may be disposed oblique to the transverse direction of the conductor 11 (in the X-axis direction in FIG. 1 from the end of the straight portion 111D), and the straight portion 111D may be disposed oblique to the longitudinal direction of the conductor 11 (in the Y-axis direction in FIG. 1 from the end of the straight portion 111C).

The conductor 13 has cut portions 131-1 and cut portions 131-2.

The cut portions 131-1 and/or the cut portions 131-2 may be disposed at regular intervals or may be disposed at irregular intervals in the conductor 13. In FIG. 1, in the conductor 13, cut portions 131-1 and cut portions 131-2 are alternately disposed at regular intervals in the X-axis direction in FIG. 1, and a plurality of cut portions 131-1 and a plurality of cut portions 131-2 that form a row in the Y-axis direction are alternately disposed at regular intervals. Note that a mutual distance between a cut portion 131-1 and a cut portion 131-2 adjacent in the X-axis direction may be arbitrary, and a mutual distance between a plurality of cut portions 131-1 that form a row in the Y-axis direction and a plurality of cut portions 131-2 that form a row in the Y-axis direction may be arbitrary. The cut portions 131-1 and the cut portions 131-2 may be disposed over the entire conductor 13 as illustrated in FIG. 1 or may be disposed in a part of the conductor 13.

A cut portion 131-1 is constituted of two straight portions 131A and 131B, and a cut portion 131-2 is constituted of two straight portions 131C and 131D.

The cut portion 131-1 has a similar configuration (shape) to that of the cut portion 111-1, and thus a detailed description thereof will be omitted. Further, the cut portion 131-2 has a similar configuration (shape) to that of the cut portion 111-2, and thus a detailed description thereof will be omitted.

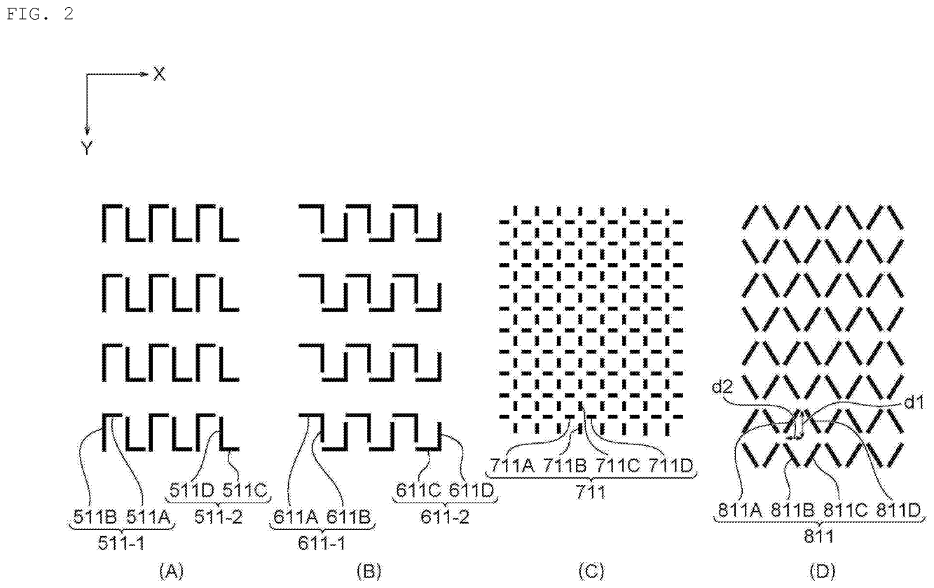

The cut portion will be described in more detail with reference to FIG. 2. FIG. 2 are views illustrating examples of the shape of the cut portion.

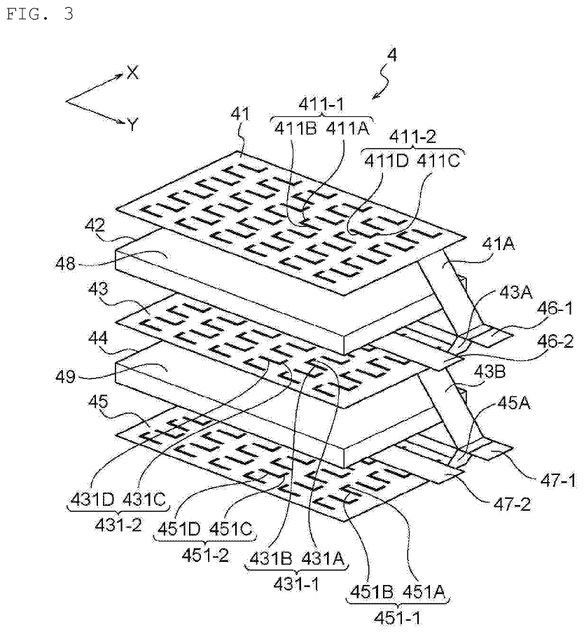

The examples of the shape of the cut portion illustrated in FIG. 2 can be applied to the battery of the first embodiment according to the present technology. Note that a cut portion 511-1 constituted of two straight portions 511A and 511B and a cut portion 511-2 constituted of two straight portions 511C and 511D illustrated in FIG. 2(A) have the same shapes as the cut portions 111-1 and 111-2 and 131-1 and 131-2 illustrated in FIG. 1, and 411-1 and 411-2, 431-1 and 431-2, and 451-1 and 451-2 illustrated in FIG. 3, and thus a detailed description thereof will be omitted here.

FIG. 2(B) is a view illustrating cut portions 611-1 and 611-2.

The cut portions 611-1 and/or the cut portions 611-2 may be disposed at regular intervals or may be disposed at irregular intervals in a conductor (not illustrated). In FIG. 2(B), in the conductor, cut portions 611-1 and cut portions 611-2 are alternately disposed at regular intervals in the X-axis direction in FIG. 2, and a plurality of cut portions 611-1 and a plurality of cut portions 611-2 that form a row in the Y-axis direction are alternately disposed at regular intervals. Note that a mutual distance between a cut portion 611-1 and a cut portion 611-2 adjacent in the X-axis direction may be arbitrary, and a mutual distance between a plurality of cut portions 611-1 that form a row in the Y-axis direction and a plurality of cut portions 611-2 that form a row in the Y-axis direction may be arbitrary. The cut portions 611-1 and the cut portions 611-2 may be disposed over the entire conductor or may be disposed in a part of the conductor.

A cut portion 611-1 is constituted of two straight portions 611A and 611B, and the straight portion 611B extends from an end of the straight portion 611A in a direction substantially perpendicular to the straight portion 611A. That is, the straight portion 611B extends from the end of the straight portion 611A in the Y-axis direction in FIG. 2, while the straight portion 611A extends from an end of the straight portion 611B in a direction opposite to the X-axis direction in FIG. 2. The cut portion 611-1 has what is called a bent shape and an L shape. Note that in FIG. 2, the straight portion 611B extends from the end of the straight portion 611A in the direction substantially perpendicular to the straight portion 611A, but does not have to extend in the substantially perpendicular direction and may extend, for example, in an acute angle direction or an obtuse angle direction.

The cut portion 611-1 may penetrate or may not penetrate therethrough. That is, both the straight portion 611A and the straight portion 611B constituting the cut portion 611-1 may penetrate or may not penetrate therethrough, or the straight portion 611A may penetrate therethrough and the straight portion 611B may not penetrate therethrough, or the straight portion 611A may not penetrate therethrough and the straight portion 611B may penetrate therethrough. When not penetrating therethrough, it is sufficient if a thickness of the cut portion 611-1 (the straight portions 611A and/or 611B) (in FIG. 2(B), a thickness in a direction substantially perpendicular to the X-axis direction and the Y-axis direction) is thinner than a thickness in a peripheral region of the cut portion 611-1 (a thickness of the conductor itself) (in FIG. 2(B), the thickness in the direction substantially perpendicular to the X-axis direction and the Y-axis direction).

Lengths of the straight portions 611A and 611B are not particularly limited, but are preferably approximately lengths such that when the battery of the first embodiment (a battery module of a second embodiment which will be described later) is damaged by an external force, the cut portion 611-1 surely bends along two straight portions 611A and 611B in order to ensure a short circuit and secure safety. For example, the lengths of the straight portions 611A and/or 611B are such that when a direction of a broken cross section of a battery element (not illustrated in FIG. 2) is a direction substantially perpendicular to the X-axis direction and the Y-axis direction (XY plane) in FIG. 2(B), the lengths may be approximately the same as a thickness of the battery element (in FIG. 2(B), a thickness in the direction substantially perpendicular to the X-axis direction and the Y-axis direction (XY plane)), or when the direction of the broken cross section of the battery element is approximately 45 degrees oblique from a perpendicular line to the X-axis direction and the Y-axis direction (XY plane) in FIG. 2(B), the lengths may be approximately a value obtained by multiplying the thickness of the battery element by root 2 (√2), or when the direction of the broken cross section of the battery element is approximately 60 degrees oblique from the perpendicular direction to the X-axis direction and the Y-axis direction (XY plane) in FIG. 2(B), the lengths may be approximately twice the thickness of the battery element. That is, the length of the straight portion 611B is preferably equal to or more than the thickness of the battery element and equal to or less than twice the thickness of the battery element.

The straight portions 611A and 611B may have different lengths from each other or may have the same lengths as each other. As illustrated in FIG. 2(B), the length of the straight portion 611B is preferably larger than the length of the straight portion 611A. This is because this preferred mode can ensure a short circuit and improve safety.

In FIG. 2(B), although the straight portion 611A is disposed in the direction opposite to the X-axis direction in FIG. 2(B) from the end of the straight portion 611B, and the straight portion 611B is disposed in the Y-axis direction in FIG. 2(B) from the end of the straight portion 611A, the straight portion 611A may be disposed oblique to the direction opposite to the X-axis direction in FIG. 2(B) from the end of the straight portion 611B, and the straight portion 611B may be disposed oblique to the Y-axis direction in FIG. 2B from the end of the straight portion 611A.

A cut portion 611-2 is constituted of two straight portions 611C and 611D, and the straight portion 611D extends from an end of the straight portion 611C in a direction substantially perpendicular to the straight portion 611C. That is, the straight portion 611D extends from the end of the straight portion 611C in the Y-axis direction in FIG. 2, while the straight portion 611C extends from an end of the straight portion 611D in a direction opposite to the X-axis direction in FIG. 2. The cut portion 611-2 has what is called a bent shape and an L shape. Note that in FIG. 2, the straight portion 611D extends from the end of the straight portion 611C in a direction substantially perpendicular to the straight portion 611C, but does not have to extend in the substantially perpendicular direction and may extend, for example, in an acute angle direction or an obtuse angle direction.

The cut portion 611-2 may penetrate or may not penetrate therethrough. That is, both the straight portion 611C and the straight portion 611D constituting the cut portion 611-2 may penetrate or may not penetrate therethrough, or the straight portion 611C may penetrate therethrough and the straight portion 611D may not penetrate therethrough, or the straight portion 611C may not penetrate therethrough and the straight portion 611D may penetrate therethrough. When not penetrating therethrough, it is sufficient if a thickness of the cut portion 611-2 (the straight portions 611C and/or 611D) (in FIG. 2(B), a thickness in a direction substantially perpendicular to the X-axis direction and the Y-axis direction) is thinner than a thickness in a peripheral region of the cut portion 611-1 (a thickness of the conductor itself) (in FIG. 2(B), the thickness in the direction substantially perpendicular to the X-axis direction and the Y-axis direction).

Lengths of the straight portions 611C and 611D are not particularly limited, but are preferably approximately lengths such that when the battery of the first embodiment (a battery module of a second embodiment which will be described later) is damaged by an external force, the cut portion 611-2 surely bends along two straight portions 611C and 611D in order to ensure a short circuit and secure safety. For example, the lengths of the straight portions 611C and/or 611D are such that when the direction of the broken cross section of the battery element (not illustrated in FIG. 2) is a direction substantially perpendicular to the X-axis direction and the Y-axis direction (XY plane) in FIG. 2(B), the lengths may be approximately the same as a thickness of the battery element (in FIG. 2(B), a thickness in the direction substantially perpendicular to the X-axis direction and the Y-axis direction (XY plane)), or when the direction of the broken cross section of the battery element is approximately 45 degrees oblique from a perpendicular line to the X-axis direction and the Y-axis direction (XY plane) in FIG. 2(B), the lengths may be approximately a value obtained by multiplying the thickness of the battery element by root 2 (√2), or when the direction of the broken cross section of the battery element is approximately 60 degrees oblique from the perpendicular direction to the X-axis direction and the Y-axis direction (XY plane) in FIG. 2(B), the lengths may be approximately twice the thickness of the battery element. That is, the length of the straight portion 611D is preferably equal to or more than the thickness of the battery element and equal to or less than twice the thickness of the battery element.

The straight portions 611C and 611D may have different lengths from each other or may have the same lengths as each other. As illustrated in FIG. 2(B), the length of the straight portion 611D is preferably larger than the length of the straight portion 611C. This is because this preferred mode can ensure a short circuit and improve safety.

In FIG. 2(B), although the straight portion 611C is disposed in the direction opposite to the X-axis direction in FIG. 2(B) from the end of the straight portion 611D, and the straight portion 611D is disposed in the Y-axis direction in FIG. 2(B) from the end of the straight portion 611C, the straight portion 611C may be disposed oblique to the direction opposite to the X-axis direction in FIG. 2(B) from the end of the straight portion 611D, and the straight portion 611D may be disposed oblique to the Y-axis direction in FIG. 2(B) from the end of the straight portion 611C.

FIG. 2(C) is a view illustrating cut portions 711.

The cut portions 711 may be disposed at regular intervals or may be disposed at irregular intervals in a conductor (not illustrated). In FIG. 2(C), cut portions 711 are disposed at regular intervals in the conductor in the X-axis direction and the Y-axis direction in FIG. 2. Note that a mutual distance between two cut portions 711 adjacent in the X-axis direction and a mutual distance between two cut portions 711 adjacent in the Y-axis direction may be arbitrary. The cut portions 711 may be disposed over the entire conductor or may be disposed in a part of the conductor.

A cut portion 711 is constituted of four straight portions 711A to 711D and has what is called a cross shape. From a center of the cross shape, the straight portion 711A extends in a direction opposite to the X-axis direction in FIG. 2, the straight portion 711B extends in the Y-axis direction in FIG. 2, the straight portion 711C extends in a direction opposite to the Y-axis direction in FIG. 2, and the straight portion 711D extends in the X-axis direction in FIG. 2.

The cut portion 711 may penetrate or may not penetrate therethrough.

That is, all of the straight portions 711A to 711D constituting the cut portion 711 may penetrate or may not penetrate therethrough, or at least one of the straight portions 711A to 711D may penetrate therethrough. When not penetrating therethrough, it is sufficient if a thickness of the cut portion 711 (the straight portions 711A to 711D) (in FIG. 2(C), a thickness in the direction substantially perpendicular to the X-axis direction and the Y-axis direction) is thinner than a thickness in a peripheral region of the cut portion 711 (a thickness of the conductor itself) (in FIG. 2(C), the thickness in the direction substantially perpendicular to the X-axis direction and the Y-axis direction).

Lengths of the straight portions 711A to 711D are not particularly limited, but are preferably approximately lengths such that when the battery of the first embodiment (a battery module of a second embodiment which will be described later) is damaged by an external force, the cut portion 711 surely bends along the four straight portions 711A to 711D in order to ensure a short circuit and secure safety. For example, the lengths of the straight portions 711A to 711D are such that when a direction of a broken cross section of a battery element (not illustrated in FIG. 2) is a direction substantially perpendicular to the X-axis direction and the Y-axis direction (XY plane) in FIG. 2(C), the lengths may be approximately the same as a thickness of the battery element (in FIG. 2(C), a thickness in the direction substantially perpendicular to the X-axis direction and the Y-axis direction (XY plane)), or when the direction of the broken cross section of the battery element is approximately 45 degrees oblique from a perpendicular line to the X-axis direction and the Y-axis direction (XY plane) in FIG. 2(C), the lengths may be approximately a value obtained by multiplying the thickness of the battery element by root 2 (√2), or when the direction of the broken cross section of the battery element is approximately 60 degrees oblique from the perpendicular direction to the X-axis direction and the Y-axis direction (XY plane) in FIG. 2(C), the lengths may be approximately twice the thickness of the battery element. That is, the lengths of the straight portions 711A to 711D are preferably equal to or more than the thickness of the battery element and equal to or less than twice the thickness of the battery element.

The straight portions 711A to 711D may have different lengths from each other or may have the same lengths as each other. As illustrated in FIG. 2(C), the lengths of the straight portions 711A to 711D are preferably substantially the same lengths as each other. This is because this preferred mode can ensure a short circuit and improve safety.

FIG. 2(D) is a view illustrating cut portions 811.

The cut portions 811 may be disposed at regular intervals or may be disposed at irregular intervals in a conductor (not illustrated). In FIG. 2(D), cut portions 811 are disposed at regular intervals in the conductor in the X-axis direction and the Y-axis direction in FIG. 2. Note that a mutual distance between two cut portions 811 adjacent in the X-axis direction and a mutual distance between two cut portions 811 adjacent in the Y-axis direction may be arbitrary. The cut portions 811 may be disposed over the entire conductor or may be disposed in a part of the conductor.

A cut portion 811 is constituted of four straight portions 811A to 811D and has what is called an X-shape. From a center of the X shape, the straight portion 811A extends in a direction opposite to the X-axis direction and the Y-axis direction in FIG. 2 and in an upper left direction in FIG. 2(D), the straight portion 811B extends in a direction opposite to the X-axis direction and in the Y-axis direction and in a lower left direction in FIG. 2(D), the straight portion 811C extends in the X-axis direction and in a direction opposite to the Y-axis direction in FIG. 2 and in an upper right direction in FIG. 2(D), and the straight portion 811D extends in the X-axis direction and in the Y-axis direction in FIG. 2 and in a lower right direction in FIG. 2(D).

The cut portion 811 may penetrate or may not penetrate therethrough.

That is, all of the straight portions 811A to 811D constituting the cut portion 811 may penetrate or may not penetrate therethrough, or at least one of the straight portions 811A to 811D may penetrate therethrough. When not penetrating therethrough, it is sufficient if a thickness of the cut portion 811 (the straight portions 811A to 811D) (in FIG. 2(D), a thickness in the direction substantially perpendicular to the X-axis direction and the Y-axis direction) is thinner than a thickness in a peripheral region of the cut portion 811 (a thickness of the conductor itself) (in FIG. 2(D), the thickness in the direction substantially perpendicular to the X-axis direction and the Y-axis direction).

Lengths of the straight portions 811A to 811D are not particularly limited, but are preferably approximately lengths such that when the battery of the first embodiment (a battery module of a second embodiment which will be described later) is damaged by an external force, the cut portion 811 surely bends along the four straight portions 811A to 811D in order to ensure a short circuit and secure safety. For example, assuming that respective half lengths of two diagonal lines of a quadrangle constituted of 811A to 811D (a parallelogram in FIG. 2(D)) are defined (in FIG. 2(D), the half lengths are defined as d1 (approximately half length of a diagonal line in the Y-axis direction) and d2 (approximately half length of a diagonal line in the X-axis direction)), when a breakage of the battery element (not illustrated in FIG. 2) starts from a cut (fold) substantially parallel to the X axis in FIG. 2, and a direction of a broken cross section is a direction substantially perpendicular to the X-axis direction and the Y-axis direction (XY plane) in FIG. 2(D), the length d1 may be approximately the same as a thickness of the battery element (in FIG. 2(D), a thickness in the direction substantially perpendicular to the X-axis direction and the Y-axis direction (XY plane)). When the direction of the broken cross section of the battery element is approximately 45 degrees oblique from a perpendicular line to the X-axis direction and the Y-axis direction (XY plane) in FIG. 2(D), the length d1 may be approximately a value obtained by multiplying the thickness of the battery element by root 2 (√2). When the direction of the broken cross section of the battery element is approximately 60 degrees oblique from a perpendicular line to the X-axis direction and the Y-axis direction (XY plane) in FIG. 2(D), the length d1 may be approximately twice the thickness of the battery element. Further, when a breakage of the battery element starts from a cut (fold) substantially parallel to the Y axis in FIG. 2, and a direction of a broken cross section is a direction substantially perpendicular to the X-axis direction and the Y-axis direction (XY plane) in FIG. 2(D), the length d2 may be approximately the same as the thickness of the battery element (in FIG. 2(D), the thickness in the direction substantially perpendicular to the X-axis direction and the Y-axis direction (XY plane)). When the direction of the broken cross section of the battery element is approximately 45 degrees oblique from a perpendicular line to the X-axis direction and the Y-axis direction (XY plane) in FIG. 2(D), the length d2 may be approximately a value obtained by multiplying the thickness of the battery element by root 2 (√2). When the direction of the broken cross section of the battery element is approximately 60 degrees oblique from a perpendicular line to the X-axis direction and the Y-axis direction (XY plane) in FIG. 2(D), the length d2 may be approximately twice the thickness of the battery element. That is, d1 and d2 are preferably lengths equal to or more than the thickness of the battery element and equal to or less than twice the thickness of the battery element.

The straight portions 811A to 811D may have different lengths from each other or may have the same lengths as each other. As illustrated in FIG. 2(D), the lengths of the straight portions 811A to 811D are preferably substantially the same lengths as each other. This is because this preferred mode can ensure a short circuit and improve safety.

The battery element 12 may be constituted of a laminated electrode body made by laminating a positive electrode and a negative electrode with a separator interposed therebetween, or may be constituted of a wound electrode body made by laminating a positive electrode and a negative electrode with a separator interposed therebetween, and further winding them thereafter. When the battery element 12 is a wound electrode body, the conductor may be in a foil shape, and the conductor may be attached to an outside (outermost peripheral side) of a positive electrode current collector or a negative electrode current collector, or an outside (outermost peripheral side) of a positive electrode current collector foil or a negative electrode current collector foil may be used as a conductor.

The positive electrode is constituted of a positive electrode current collector (which may be a positive electrode current collector foil; the same applies below) and a positive electrode active material layer provided on one or both sides of the positive electrode current collector. On the other hand, the negative electrode is constituted of a negative electrode current collector (which may be a negative electrode current collector foil; the same applies below) and a negative electrode active material layer provided on one or both sides of the negative electrode current collector.

The positive electrode current collector is constituted of, for example, a metal foil such as an aluminum foil. The positive electrode active material layer includes, for example, one or more positive electrode materials that can occlude and release lithium (Li) or lithium ions (Lit) as the positive electrode active material, and includes a conductive agent such as graphite and a binder such as polyvinylidene fluoride as necessary. Examples of the positive electrode material include lithium-containing compounds such as lithium oxide, lithium phosphorus oxide, lithium sulfide, or an intercalation compound containing lithium.

The negative electrode current collector is constituted of, for example, a metal foil such as a copper foil. The negative electrode active material layer includes, for example, one or more negative electrode materials that can occlude and release lithium (Li) or lithium ions (Lit) as the negative electrode active material, and includes a conductive agent such as graphite and a binder such as polyvinylidene fluoride as necessary. Examples of the negative electrode active material include non-graphitizable carbons, graphitizable carbon, graphite, pyrolytic carbons, cokes, glassy carbons, organic polymer compound fired bodies, and carbon materials such as carbon fibers or activated carbons.

The separator is constituted of, for example, a porous film made of a polyolefin-based material such as polypropylene or polyethylene, or a porous film made of an inorganic material such as a ceramic nonwoven fabric, and may be of a structure in which two or more kinds of these porous films are laminated.

The separator is impregnated with an electrolytic solution that is liquid electrolyte. For example, this electrolytic solution includes a solvent and a lithium salt that is an electrolyte salt. The solvent dissolves and dissociates the electrolyte salt. As the solvent, propylene carbonate, ethylene carbonate, diethyl carbonate, dimethyl carbonate, 1,2-dimethoxyethane, 1,2-diethoxyethane, γ-butyrolactone, tetrahydrofuran, 2-methyltetrahydrofuran, 1,3-dioxolane, 4 methyl 1,3 dioxolane, diethyl ether, sulfolane, methyl sulfolane, acetonitrile, propionitrile, anisole, acetic acid ester, butyric acid ester, or propionic acid ester, and the like may be mentioned, and any one of these or a mixture of two or more may be used.

Examples of the lithium salt include LiClO₄, LiAsF₆, LiPF₆, LiBF₄, LiB(C₆H₅)₄, CH₃SO₃Li, CF₃SO₃Li, LiCl, or LiBr, and any one of these or a mixture of two or more may be used.

The battery element 12 may be constituted of a laminated electrode body made by laminating a positive electrode and a negative electrode with a separator and even an electrolyte layer interposed therebetween, or may be constituted of a wound electrode body made by laminating a positive electrode and a negative electrode with a separator and even an electrolyte layer interposed therebetween, and further winding them thereafter. When the battery element 12 is a wound electrode body, the conductor may be in a foil shape, and the conductor may be attached to an outside (outermost peripheral side) of a positive electrode current collector or a negative electrode current collector, or an outside (outermost peripheral side) of a positive electrode current collector foil or a negative electrode current collector foil may be used as a conductor.

The electrolyte layer is a layer in which an electrolytic solution is held by a polymer compound, and may contain other materials such as various additives as necessary. This electrolyte layer is, for example, what is called a gel electrolyte. The gel electrolyte is preferable because high ion conductivity (for example, 1 mS/cm or more at room temperature) can be obtained and leakage of the electrolytic solution is prevented.

Examples of the polymer compound include polyacrylonitrile, polyvinylidene fluoride, polytetrafluoroethylene, polyhexafluoropropylene, polyethylene oxide, polypropylene oxide, polyphosphazene, polysiloxane, polyvinyl fluoride, polyvinyl acetate, polyvinyl alcohol, polymethyl methacrylate, polyacrylic acid, polymethacrylic acid, styrene-butadiene rubber, nitrile-butadiene rubber, polystyrene, polycarbonate, or a copolymer of vinylidene fluoride and hexafluoropylene, and the like. These may be single, or multiple types may be mixed. Among these, polyvinylidene fluoride or a copolymer of vinylidene fluoride and hexafluoropyrene is preferable. This is because they are electrochemically stable.

The exterior body 14 is not particularly limited as long as it can accommodate the battery element 12, but is preferably an exterior body including a laminate material. The laminate material is, for example, a laminate film in which a fusion layer, a metal layer, and a surface protective layer are laminated in this order. The fusion layer is constituted of, for example, a polyolefin resin such as polyethylene or polypropylene. The metal layer is constituted of, for example, aluminum. The surface protective layer is constituted of, for example, nylon or polyethylene terephthalate. The exterior member 40 may be a laminate film having another laminated structure, and may be a polymer film alone or a metal film alone. Note that the exterior body may be a battery can made of, for example, iron plated with nickel.

The battery 1 can be manufactured as follows, for example.

First, a positive electrode is produced. To begin with, a positive electrode active material and, as necessary, a binder and a conductive agent are mixed to make a positive electrode mixture, and thereafter, for example, the mixture is dispersed in an organic solvent or the like to make a positive electrode mixture slurry in a paste or slurry form.

Subsequently, the positive electrode mixture slurry is uniformly applied to both surfaces of a positive electrode current collector and then dried to form a positive electrode active material layer. Finally, the positive electrode active material layer is compression molded using a roll press or the like while being heated as necessary. In this case, the compression molding may be repeated a plurality of times.

Next, a negative electrode is produced by a similar procedure to that for the positive electrode described above. To begin with, a negative electrode active material and, as necessary, a binder and a conductive agent are mixed to make a negative electrode mixture, and thereafter, for example, the mixture is dispersed in an organic solvent or the like to make a negative electrode mixture slurry in a paste or slurry form.

Thereafter, the negative electrode mixture slurry is uniformly applied to both surfaces of a negative electrode current collector and then dried to form a negative electrode active material layer, and then the negative electrode active material layer is compression molded.

A positive electrode lead is attached to the positive electrode produced as described above, and a negative electrode lead is attached to the negative electrode produced as described above. Subsequently, the positive electrode and the negative electrode are laminated on both surfaces with a separator interposed therebetween, and the fixing member 17 is adhered, thereby producing the battery element 12.

Next, the battery element 12 is sandwiched between the exterior body 14 with the conductors 11 and 13 interposed therebetween, and then a remaining outer peripheral edge portion excluding an outer peripheral edge portion on one side is adhered by thermal fusion or the like, thereby accommodating the conductors 11, 13 and the battery element 12 inside the exterior body 14.

Subsequently, after an electrolytic solution is injected into the bag-shaped exterior body 14, an opening of the exterior body 14 is sealed by heat fusion or the like, and thus the battery 1 can be obtained.

### 3. Second Embodiment (Example of Battery Module)

The battery module of the first embodiment (example of a battery module) according to the present technology is a battery module that includes a plurality of batteries and a conductor, and each of the plurality of batteries includes a battery element and an exterior body that covers the battery element, in which a conductor is disposed outside the battery element, and the conductor has a cut portion.

A battery module of a second embodiment according to the present technology can achieve a battery module having a safety mechanism that is not limited by an electrode producing process and a member used by a plurality of battery cells, and operates even when the plurality of battery cells is deformed and damaged when being subjected to unexpected pressure from the outside. That is, by using the battery module of the second embodiment according to the present technology, when the battery module is deformed and broken by an external force without affecting characteristics of the battery module, the conductive cut portion comes in contact with a broken cross section of the battery element and quickly causes a short circuit on a surface layer portion of the battery element, thereby allowing the battery to be safely damaged. Therefore, the battery module of the second embodiment according to the present technology can improve safety and achieve an excellent reliability effect.

Hereinafter, the battery module of the second embodiment (example of the battery module) according to the present technology will be described in more detail with reference to FIG. 3. FIG. 3 is an exploded perspective view illustrating a configuration example of the battery module of the second embodiment according to the present technology.

As illustrated in FIG. 3, the battery module 4 includes two batteries 42 and 44 and three conductors 41, 43 and 45. The batteries 42 and 44 are, for example, laminate film type lithium ion secondary batteries. As the batteries 42 and 44, the battery 1 described above can be applied as it is, and thus detailed descriptions of the batteries 42 and 44 will be omitted. The two batteries 42 and 44 include respective battery elements (not illustrated) and respective exterior bodies 48 and 49 that cover the two battery elements (not illustrated) respectively. Then, each of the conductors 41, 43, and 45 is disposed outside the battery elements (not illustrated), and is further disposed outside each of the exterior bodies 48 and 49. That is, the conductor 41 is disposed outside the battery 42 (in FIG. 3, above the battery 42), the conductor 43 is disposed between the battery 42 and the battery 44, and the conductor 45 is disposed outside the battery 44 (in FIG. 3, below the battery 44).

Although not illustrated in FIG. 3, respective outermost peripheral portions of the battery elements of the batteries 42 and 44 are fixed by a fixing member made of a protective tape or the like. Further, although not illustrated in FIG. 3, at least one of the conductor 41 and the conductor 43 may be disposed so as to be wound around the outermost peripheral portion of the battery 42, or at least one of the conductor 43 and the conductor 45 may be disposed so as to be wound around the outermost peripheral portion of the battery 44. In this case, the conductors 41, 43, and 45 are preferably constituted of a material having plasticity (flexibility) so that the conductors 41, 43, and 45 can be wound and bent, for example. The material of the conductors 41, 43, and 45 may be any material as long as it has conductivity, but is preferably aluminum or stainless steel (SUS). The shape of the conductors 41, 43, and 45 is not particularly limited, and examples thereof include a plate shape, a foil shape, and the like.

At least one of the conductor 41 and the conductor 43 may be electrically connected to a positive electrode tab 46-1 or a negative electrode tab 46-2. In FIG. 3, a conductor 41A (a tip piece of the conductor 41) is electrically connected to the positive electrode tab 46-1 (the positive electrode tab of the battery 42), and a conductor 43A (a tip piece of the conductor 43) is electrically connected to the positive electrode tab 46-1 (the positive electrode tab of the battery 42).

Further, at least one of the conductor 43 and the conductor 45 may be electrically connected to a positive electrode tab 47-1 or a negative electrode tab 47-2. In FIG. 3, a conductor 43B (a tip piece of the conductor 43) is electrically connected to the positive electrode tab 47-1 (the positive electrode tab of the battery 44), and a conductor 45A (a tip piece of the conductor 45) is electrically connected to the positive electrode tab 47-1 (the positive electrode tab of the battery 44).

Although not illustrated in FIG. 3, a close-contact film is inserted between the positive electrode tab 46-1 and the negative electrode tab 46-2 and the exterior body 48, and between the positive electrode tab 47-1 and the negative electrode tab 47-2 and the exterior body 49 in order to prevent intrusion of outside air.

When an external force is applied to the battery module 4, the conductors 41, 43, and/or 45 are bent or cut along cut portions 411-1 and/or 411-2 (cut portions of the conductor 41), 431-1 and/or 431-2 (cut portions of the conductor 43), and/or 451-1 and 451-2 (cut portions of the conductor 45), and any one of the above cut portions covers over a cross section of the battery element damaged by the external force, thereby causing a short circuit and ensuring safety.

The conductor 41 has cut portions 411-1 and cut portions 411-2, the conductor 43 has cut portions 431-1 and cut portions 431-2, and the conductor 45 has cut portions 451-1 and cut portions 451-2.

The cut portions 411-1 and/or the cut portions 411-2 may be disposed at regular intervals or may be disposed at irregular intervals in the conductor 41.

In FIG. 3, in the conductor 41, cut portions 411-1 and cut portions 411-2 are alternately disposed at regular intervals in the X-axis direction in FIG. 3, and a plurality of cut portions 411-1 and a plurality of cut portions 411-2 that form a row in the Y-axis direction are alternately disposed at regular intervals. Note that a mutual distance between a cut portion 411-1 and a cut portion 411-2 adjacent in the X-axis direction may be arbitrary, and a mutual distance between a plurality of cut portions 411-1 that form a row in the Y-axis direction and a plurality of cut portions 411-2 that form a row in the Y-axis direction may be arbitrary. The cut portions 411-1 and the cut portions 411-2 may be disposed over the entire conductor 41 as illustrated in FIG. 3 or may be disposed in a part of the conductor 41.

A cut portion 411-1 is constituted of two straight portions 411A and 411B, and a cut portion 411-2 is constituted of two straight portions 411C and 411D.

The cut portions 431-1 and/or the cut portions 431-2 may be disposed at regular intervals or may be disposed at irregular intervals in the conductor 43.

In FIG. 3, in the conductor 43, cut portions 431-1 and cut portions 431-2 are alternately disposed at regular intervals in the X-axis direction in FIG. 3, and a plurality of cut portions 431-1 and a plurality of cut portions 431-2 that form a row in the Y-axis direction are alternately disposed at regular intervals. Note that a mutual distance between a cut portion 431-1 and a cut portion 431-2 adjacent in the X-axis direction may be arbitrary, and a mutual distance between a plurality of cut portions 431-1 that form a row in the Y-axis direction and a plurality of cut portions 431-2 that form a row in the Y-axis direction may be arbitrary. The cut portions 431-1 and the cut portions 431-2 may be disposed over the entire conductor 43 as illustrated in FIG. 3 or may be disposed in a part of the conductor 43.

A cut portion 431-1 is constituted of two straight portions 431A and 431B, and a cut portion 431-2 is constituted of two straight portions 431C and 431D.

The cut portions 451-1 and/or the cut portions 451-2 may be disposed at regular intervals or may be disposed at irregular intervals in the conductor 45.

In FIG. 3, in the conductor 45, cut portions 451-1 and cut portions 451-2 are alternately disposed at regular intervals in the X-axis direction in FIG. 3, and a plurality of cut portions 451-1 and a plurality of cut portions 451-2 that form a row in the Y-axis direction are alternately disposed at regular intervals. Note that a mutual distance between a cut portion 451-1 and a cut portion 451-2 adjacent in the X-axis direction may be arbitrary, and a mutual distance between a plurality of cut portions 451-1 that form a row in the Y-axis direction and a plurality of cut portions 451-2 that form a row in the Y-axis direction may be arbitrary. The cut portions 451-1 and the cut portions 451-2 may be disposed over the entire conductor 45 as illustrated in FIG. 3 or may be disposed in a part of the conductor 45.

A cut portion 451-1 is constituted of two straight portions 451A and 451B, and a cut portion 451-2 is constituted of two straight portions 451C and 451D.

The cut portions 411-1, 431-1, and 451-1 have a similar configuration (shape) to that of the cut portions 111-1, and thus detailed descriptions thereof will be omitted. Further, the cut portions 411-2, 431-2, and 451-2 have a similar configuration (shape) to that of the cut portion 111-2, and thus detailed descriptions thereof will be omitted.

To the battery module of the second embodiment according to the present technology, the examples of the shapes of the cut portions illustrated in FIG. 2 described above may be applied, similarly to the battery of the first embodiment according to the present technology.

### 4. Applications of Batteries and Battery Modules

Applications of the battery and the battery module will be described in detail below.

### 4-1. Overview of Applications of Battery and Battery Module

Applications of the battery and the battery module will not be specifically limited as long as they are machines, appliances, instruments, devices, and systems (a collection of multiple appliances) that can use the battery and battery module as a power source for driving or power storage source for storing power, or the like. The battery and the battery module used as the power source may be a main power source (a power source used preferentially) or an auxiliary power source (a power source used in place of or switched from the main power source). When a battery or a battery module is used as an auxiliary power source, the type of the main power source is not limited to the battery and the battery module.

Examples of applications of the battery and the battery module include the following. Laptop personal computers, tablet computers, mobile phones (for example, smart phones), personal digital assistants (PDA), imaging devices (for example, digital still cameras, digital video cameras, and the like), audio devices (for example, portable audio players), game devices, cordless phone handsets, electronic books, electronic dictionaries, radios, headphones, navigation systems, memory cards, pacemakers, hearing aids, lighting devices, toys, medical devices, robots, and other electronic devices (including portable electronic devices). Portable household appliances such as electric shavers. Storage devices such as backup power supplies and memory cards. Power tools such as electric drills and electric saws. Battery packs used for laptop computers or the like as detachable power sources. Medical electronic devices such as pacemakers and hearing aids. Vehicles used as electric vehicles (including hybrid vehicles). Power storage systems such as home battery systems that store electric power in case of emergency. Of course, other uses may be chosen. Note that the battery module is not particularly limited and is applied to machines, appliances, instruments, devices, and systems (an assembly such as a plurality of devices), and the like, but is particularly preferably applied to large machines, appliances, instruments, devices, and systems (an assembly such as a plurality of devices), and the like that has a large amount of power consumption.

The battery is particularly effective when applied to a battery pack, a vehicle, a power storage system, a power tool, and an electronic device. Further, the battery module is particularly effective when applied to a vehicle, a power storage system, and an electronic device. Because excellent reliability is required, it is possible to effectively improve battery reliability by using the battery or the battery module according to the present technology. Note that the battery pack is a power source using a battery, and is what is called an assembled battery or the like. The vehicle is a vehicle that operates (runs) using the battery or the battery module as a driving power source, and as described above, the vehicle may be a car (a hybrid car or the like) that is provided with a driving source other than the battery and the battery module. An example of the power storage system is a power storage system for a house, and is a system that uses the battery or the battery module as a power storage source. In the power storage system, electric power is stored in the battery or the battery module that is a power storage source, and thus a power consumption apparatus, for example, a household electric product can be used by using the electric power. The electric power tool is a tool in which a movable part (for example, a drill or the like) moves using the battery as a power source for driving. The electronic device is a device that exhibits various functions using a battery or a battery module as a power source for driving (power supply source).

Here, some application examples of the battery and the battery module will be specifically described. Note that the configuration of each application example described below is merely an example, and thus can be changed as appropriate.

### 4-2. Third Embodiment (Example of Battery Pack)

A battery pack of a third embodiment according to the present technology includes the battery of the first embodiment according to the present technology. For example, the battery pack of the third embodiment according to the present technology is a battery pack that includes the battery of the first embodiment according to the present technology, a control unit that controls a use state of the battery, and a switch unit that switches the use state of the battery according to an instruction from the control unit. The battery pack of the third embodiment according to the present technology includes the battery of the first embodiment according to the present technology having excellent reliability, which leads to improvement in reliability such as safety of the battery pack.

Hereinafter, the battery pack of the third embodiment according to the present technology will be described with reference to the drawings.

FIG. 7 illustrates a block configuration of the battery pack. This battery pack includes, for example, a control unit 61, a power source 62, a switch unit 63, a current measurement unit 64, a temperature detection unit 65, a voltage detection unit 66, a switch control unit 67, a memory 68, a temperature detection element 69, a current detection resistor 70, a positive electrode terminal 71, and a negative electrode terminal 72 inside a housing 60 formed of a plastic material or the like.

The control unit 61 controls operation of the entire battery pack (including a use state of the power source 62), and includes, for example, a central processing unit (CPU) or the like. The power source 62 includes one or more batteries (not illustrated). The power source 62 is, for example, an assembled battery including two or more batteries, and a connection type of these batteries may be in series, in parallel, or a mixture of both. As an example, the power source 62 includes six batteries connected, two in parallel and three in series.

The switch unit 63 switches the use state of the power source 62 (whether or not the power source 62 can be connected to an external device) according to an instruction from the control unit 61. The switch unit 63 includes, for example, a charge control switch, a discharge control switch, a charging diode, a discharging diode (all not illustrated) and the like. The charge control switch and the discharge control switch are semiconductor switches such as a field effect transistor using a metal oxide semiconductor (MOSFET), for example.

The current measurement unit 64 measures a current using the current detection resistor 70 and outputs a measurement result thereof to the control unit 61. The temperature detection unit 65 measures a temperature using the temperature detection element 69 and outputs a measurement result thereof to the control unit 61. This temperature measurement result is used, for example, when the control unit 61 performs charge-discharge control during abnormal heat generation, or when the control unit 61 performs a correction process when calculating a remaining capacity. The voltage detection unit 66 measures a voltage of the battery in the power source 62, converts a measured voltage thereof from analog to digital, and supplies a converted voltage to the control unit 61.

The switch control unit 67 controls operation of the switch unit 63 according to signals input from the current measurement unit 64 and the voltage detection unit 66.

For example, when a battery voltage reaches an overcharge detection voltage, the switch control unit 67 performs control to disconnect the switch unit 63 (charge control switch), so that a charging current does not flow through a current path of the power source 62. Thus, the power source 62 can only be discharged through the discharging diode. Note that the switch control unit 67 is configured to cut off the charging current when a large current flows during charging, for example.

Further, for example, when the battery voltage reaches the overdischarge detection voltage, the switch control unit 67 performs control to disconnect the switch unit 63 (discharge control switch), so that a discharging current does not flow through the current path of the power source 62. Thus, the power source 62 can only be charged through the charging diode. Note that the switch control unit 67 is configured to cut off the discharging current when a large current flows during discharging, for example.

Note that in the battery, for example, the overcharge detection voltage is 4.2 V±0.05 V, and the overdischarge detection voltage is 2.4 V±0.1 V.

The memory 68 is, for example, an EEPROM that is a nonvolatile memory.

The memory 68 stores, for example, numerical values calculated by the control unit 61, battery information (for example, internal resistance in an initial state) measured in a manufacturing process stage, and the like. Note that if a full charge capacity of the secondary battery is stored in the memory 68, the control unit 61 can comprehend information such as a remaining capacity.

The temperature detection element 69 measures a temperature of the power source 62 and outputs a measurement result thereof to the control unit 61, and is a thermistor, for example.

The positive electrode terminal 71 and the negative electrode terminal 72 are terminals connected to an external device (for example, a laptop personal computer) that is operated using the battery pack, or an external device (for example, a charger) that is used to charge the battery pack. Charging or discharging of the power source 62 is performed via the positive electrode terminal 71 and the negative electrode terminal 72.

### 4-3. Fourth Embodiment (Example of Vehicle)

A vehicle of a fourth embodiment according to the present technology is a vehicle that includes the battery of the first embodiment according to the present technology, a driving force conversion apparatus that converts electric power supplied from the battery into a driving force, a driving unit that drives according to the driving force, and a vehicle control device. Further, the vehicle of the fourth embodiment according to the present technology is a vehicle that includes the battery module of the second embodiment according to the present technology, a driving force conversion apparatus that converts electric power supplied from the battery module into a driving force, a driving unit that drives according to the driving force, and a vehicle control device. The vehicle of the fourth embodiment according to the present technology includes the battery of the first embodiment or the battery module of the second embodiment according to the present technology having excellent reliability, which leads to improvement in reliability such as safety of the vehicle.

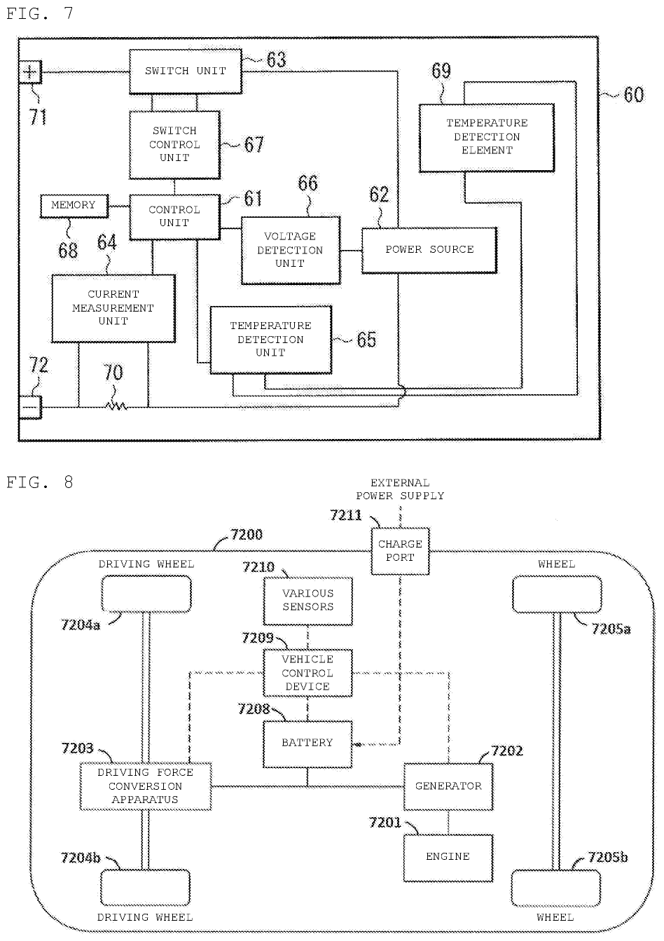

Hereinafter, the vehicle of the fourth embodiment according to the present technology will be described with reference to FIG. 8.

FIG. 8 schematically illustrates an example of a configuration of a hybrid vehicle that employs a series hybrid system to which the present technology is applied. The series hybrid system is a car that runs by a power-driving force conversion apparatus using electric power generated by a generator driven by an engine or electric power once stored in a battery.

This hybrid vehicle 7200 is provided with an engine 7201, a generator 7202, a power-driving force conversion apparatus 7203, a driving wheel 7204a, a driving wheel 7204b, a wheel 7205a, a wheel 7205b, a battery 7208, a vehicle control device 7209, various sensors 7210, and a charge port 7211. A power storage device (not illustrated) is applied to the battery 7208.

The hybrid vehicle 7200 runs using the power-driving force conversion apparatus 7203 as a power source. An example of the power-driving force conversion apparatus 7203 is a motor. The power-driving force conversion apparatus 7203 is operated by electric power of the battery 7208, and rotational force of this power-driving force conversion apparatus 7203 is transmitted to the driving wheels 7204a, 7204b. Note that also by using direct current-alternate current (DC-AC) or reverse conversion (AC-DC conversion) where necessary, the power-driving force conversion apparatus 7203 can be applied to either an AC motor or a DC motor. The various sensors 7210 control an engine speed through the vehicle control device 7209, and control opening (throttle opening) of a throttle valve that is not illustrated. The various sensors 7210 include a speed sensor, an acceleration sensor, an engine speed sensor, and the like.

The rotational force of the engine 7201 is transmitted to the generator 7202, and electric power generated by the generator 7202 from the rotational force can be stored in the battery 7208.

When the hybrid vehicle decelerates by a braking mechanism that is not illustrated, a resistance force during the deceleration is applied as a rotational force to the power-driving force conversion apparatus 7203, and regenerative power generated by the power-driving force conversion apparatus 7203 from this rotational force is stored in the battery 7208.

By being connected to a power source outside the hybrid vehicle, the battery 7208 can be supplied with electric power from the external power source through the charge port 211 as an input port, and can also store the received power.

Although not illustrated, an information processing device that performs information processing related to vehicle control based on information related to the battery or the battery module may be included. As such an information processing device, for example, there is an information processing device that displays a remaining battery level based on information related to a remaining level of the battery or the battery module.

Note that in the above description, a series hybrid vehicle running with a motor using electric power generated by a generator driven by an engine or electric power stored once in a battery has been described as an example. However, the present technology is also effectively applicable to a parallel hybrid vehicle that uses outputs of both the engine and the motor as driving sources, and appropriately switches between three modes: running with the engine alone, running with the motor alone, and running with the engine and the motor. Furthermore, the present technology is also effectively applicable to what is called an electric vehicle that is driven only by a drive motor to run without using an engine.

### 4-4. Fifth Embodiment (Example of Power Storage System)

A power storage system of a fifth embodiment according to the present technology is a power storage system including a power storage device that has the battery of the first embodiment according to the present technology, a power consumption apparatus to which power is supplied from the battery, a control device that controls power supply from the battery module to the power consumption apparatus, and a power generation apparatus that charges the battery. Further, the power storage system of the fifth embodiment according to the present technology is a power storage system including a power storage device that has the battery module of the second embodiment according to the present technology, a power consumption apparatus to which electric power is supplied from the battery module, a control device that controls power supply from the battery module to the power consumption apparatus, and a power generation apparatus that charges the battery module. The power storage system of the fifth embodiment according to the present technology includes the battery of the first embodiment according to the present technology or the battery module of the second embodiment according to the present technology having excellent reliability, which leads to improvement in reliability of the power storage system.

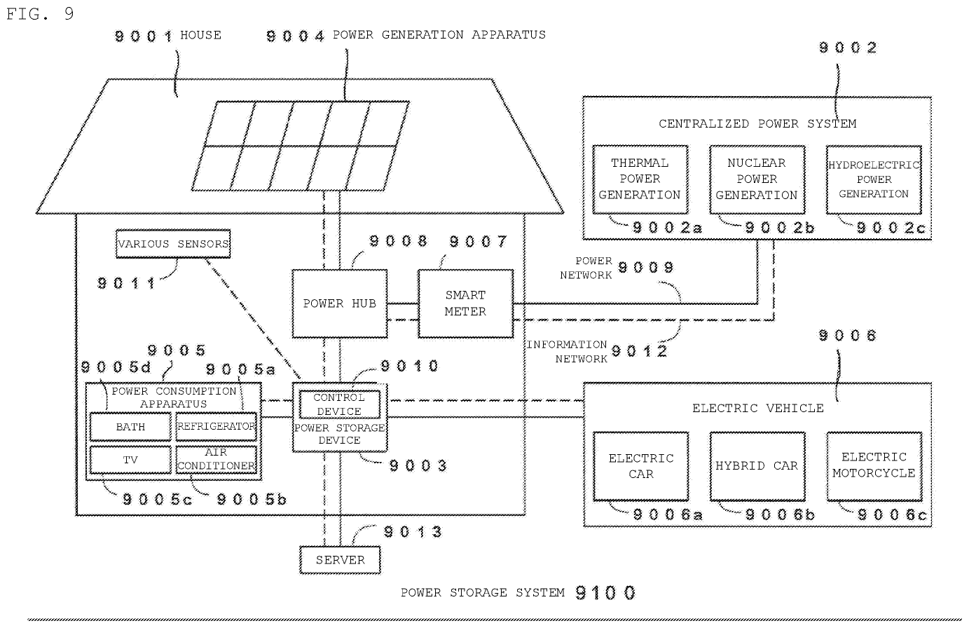

Hereinafter, a power storage system for a house that is an example of the power storage system of the fifth embodiment according to the present technology will be described with reference to FIG. 9.

For example, in a power storage system 9100 for a house 9001, electric power is supplied to a power storage device 9003 from a centralized power system 9002 such as thermal power generation 9002a, nuclear power generation 9002b, and hydroelectric power generation 9002c via a power network 9009, an information network 9012, a smart meter 9007, a power hub 9008, and/or the like. At the same time, electric power is supplied to the power storage device 9003 from an independent power source such as a home power generation apparatus 9004. The supplied electric power is stored in the power storage device 9003. Electric power used in the house 9001 is supplied using the power storage device 9003. A similar power storage system can be used not only for the house 9001 but also for buildings.

The house 9001 is provided with a power generation apparatus 9004, a power consumption apparatus 9005, a power storage device 9003, a control device 9010 that controls respective devices, a smart meter 9007, and a sensor 9011 that obtains various types of information. The respective devices are connected by a power network 9009 and an information network 9012. As the power generation apparatus 9004, a solar cell, a fuel cell, or the like is used, and generated electric power is supplied to the power consumption apparatus 9005 and/or the power storage device 9003. The power consumption apparatus 9005 is a refrigerator 9005a, an air conditioner 9005b, a television receiver 9005c, a bath 9005d, and the like. Further, the power consumption apparatus 9005 includes an electric vehicle 9006. The electric vehicle 9006 is an electric car 9006a, a hybrid car 9006b, and an electric motorcycle 9006c.

The battery of the first embodiment or the battery module (battery unit) of the second embodiment according to the present technology described above is applied to the power storage device 9003.

The power storage device 9003 includes a battery, a battery module, or a capacitor. For example, it is constituted of a lithium ion battery. The lithium ion battery may be a stationary type or one used in the electric vehicle 9006. The smart meter 9007 includes a function of measuring the amount of commercial power used and transmitting the measured amount used to an electric power company. The power network 9009 may combine one or more of direct current feed, alternate current feed, or non-contact feed.

The various sensors 9011 are, for example, a human sensor, an illuminance sensor, an object detection sensor, a power consumption sensor, a vibration sensor, a contact sensor, a temperature sensor, an infrared sensor, and the like. Information obtained by the various sensors 9011 is transmitted to the control device 9010. Based on information from the sensor 9011, weather conditions, conditions of a person, and the like can be comprehended, and the power consumption apparatus 9005 can be automatically controlled to minimize the energy consumption. Furthermore, the control device 9010 can transmit information on the house 9001 to an outside power company or the like via the Internet.

The power hub 9008 performs processes such as branching of power lines and DC-AC conversion. As a communication method of the information network 9012 connected to the control device 9010, there is a method using a communication interface such as universal asynchronous receiver-transmitter (UART), or a method using a sensor network based on a wireless communication standard such as Bluetooth (registered trademark), ZigBee (registered trademark), or Wi-Fi. The Bluetooth (registered trademark) system is applied to multimedia communication and can perform one-to-many connection communication. ZigBee uses the physical layer of IEEE (Institute of Electrical and Electronics Engineers) 802.15.4. IEEE802.15.4 is the name of a short-range wireless network standard called a personal area network (PAN) or a wireless (W) PAN.

The control device 9010 is connected to a server 9013 of the outside. The server 9013 may be managed by any one of the house 9001, a power company, and a service provider. Information transmitted or received by the server 9013 is, for example, power consumption information, life pattern information, power charges, weather information, natural disaster information, and information on power trades. These pieces of information may be transmitted and received from a power consumption apparatus inside a house (for example, a television receiver), but may be transmitted and received from a device outside the house (for example, a mobile phone or the like). Such information may be displayed on a device having a display function, for example, a television receiver, a mobile phone, a personal digital assistant (PDA), or the like.

A control device 9010 that controls each unit is constituted of a CPU, a random access memory (RAM), a read only memory (ROM), and so on, and is accommodated in the power storage device 9003 in this example. The control device 9010 is connected to the power storage device 9003, the home power generation apparatus 9004, the power consumption apparatus 9005, the various sensors 9011, and the server 9013 by the information network 9012, and has, for example, a function of adjusting the amount of commercial power used and the amount of power generated. Note that a function of performing a power trade in an electricity market, or the like may be provided.

As described above, not only electric power from the centralized power system 9002 such as the thermal power 9002a, the nuclear power 9002b, and the hydropower 9002c but generated electric power of the home power generation apparatus 9004 (solar power generation, or wind power generation) can be stored in the power storage device 9003.

Therefore, even when generated electric power of the home power generation apparatus 9004 fluctuates, it is possible to perform control such that the amount of power sent to the outside is constant or discharged as necessary. For example, the power storage system can be used such that electric power obtained by solar power generation is stored in the power storage device 9003 and midnight power at a low electricity charge is stored in the power storage device 9003 at night, and the electric power stored in the power storage device 9003 is discharged and used in a time zone of the daytime at a high electricity charge.

Note that although an example in which the control device 9010 is stored in the power storage device 9003 has been described in this example, it may be stored in the smart meter 9007 or may be configured alone. Furthermore, the power storage system 9100 may be used for a plurality of homes in an apartment house, or may be used for a plurality of detached houses.

### 4-5. Sixth Embodiment (Example of Power Tool)

A power tool of a sixth embodiment according to the present technology is a power tool including the battery of the first embodiment according to the present technology and a movable part to which electric power is supplied from the battery.

The power tool of the sixth embodiment according to the present technology includes the battery of the first embodiment according to the present technology having excellent reliability, which leads to improvement in reliability such as safety of the power tool.

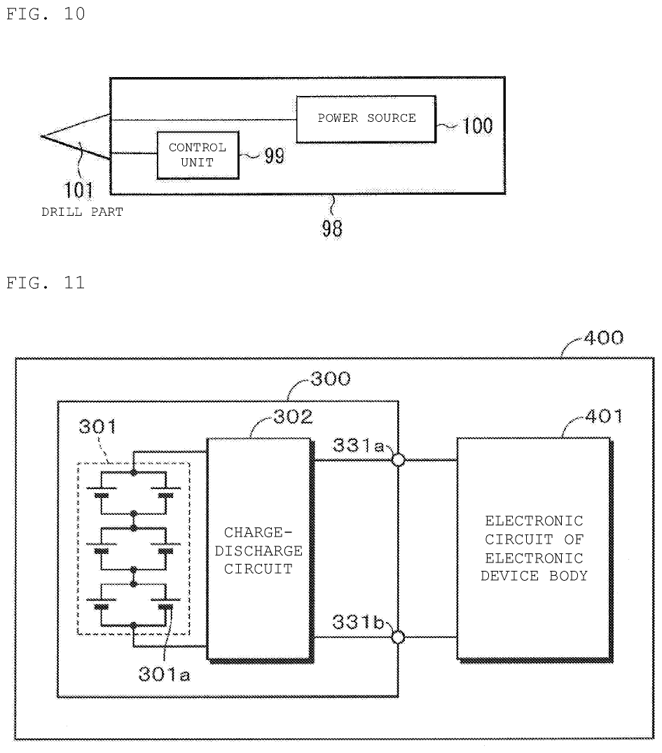

Hereinafter, a power tool of a sixth embodiment according to the present technology will be described with reference to FIG. 10.

FIG. 10 illustrates a block configuration of the electric power tool. This power tool is, for example, an electric drill, and includes a control unit 99 and a power source 100 inside a tool main body 98 formed of a plastic material or the like. For example, a drill part 101, which is a movable part, is operationally (rotatably) mounted to the tool main body 98.

The control unit 99 controls operation of the entire power tool (including a use state of the power source 100), and includes, for example, a CPU and so on. The power source 100 includes one or more batteries (not illustrated). The control unit 99 supplies electric power from the power source 100 to the drill part 101 in response to an operation of an operating switch that is not illustrated.

### 4-6. Seventh Embodiment (Example of Electronic Device)

An electronic device of a seventh embodiment according to the present technology is an electronic device that includes the battery of the first embodiment according to the present technology and receives power supply from the battery. Further, an electronic device of the seventh embodiment according to the present technology is an electronic device that includes the battery module of the second embodiment according to the present technology and receives power supply from the battery module. As described above, the electronic device of the seventh embodiment according to the present technology is a device that exhibits various functions using a battery or a battery module as a power source for driving (power supply source). The electronic device of the seventh embodiment according to the present technology includes the battery of the first embodiment according to the present technology or the battery module of the second embodiment according to the present technology having excellent reliability, which leads to improvement in reliability such as safety of the electronic device. Note that the electric power tool of the sixth embodiment described above may be regarded as an example of the electronic device of the seventh embodiment.

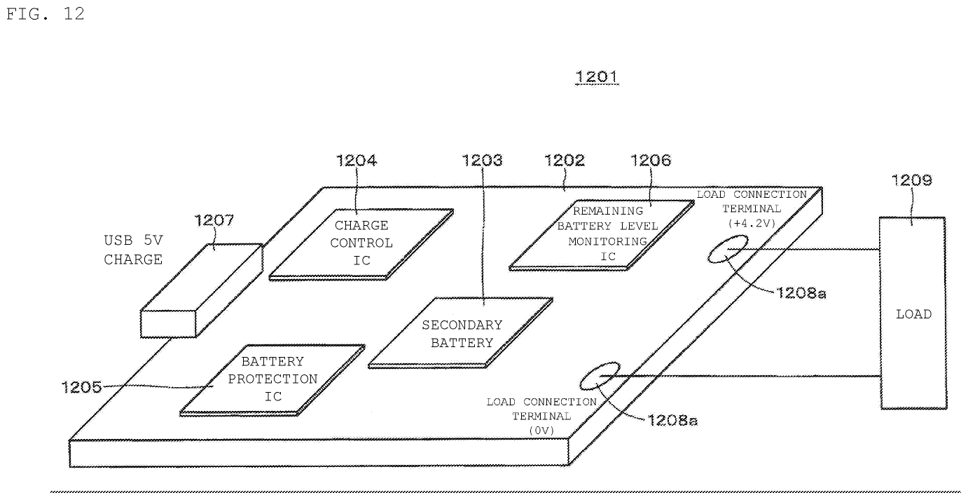

Hereinafter, an electronic device of a seventh embodiment according to the present technology will be described with reference to FIG. 11.

An example of a configuration of an electronic device 400 according to the seventh embodiment of the present technology will be described. The electronic device 400 includes an electronic circuit 401 of an electronic device body and a battery pack 300. The battery pack 300 is electrically connected to the electronic circuit 401 with a positive electrode terminal 331a and a negative electrode terminal 331b interposed therebetween. For example, the electronic device 400 has a configuration in which the battery pack 300 can be freely attached and detached by a user. Note that the configuration of the electronic device 400 is not limited to this, and may have a configuration in which the battery pack 300 is built in the electronic device 400 so that the user cannot remove the battery pack 300 from the electronic device 400.

When the battery pack 300 is charged, the positive electrode terminal 331a and the negative electrode terminal 331b of the battery pack 300 are connected to a positive electrode terminal and a negative electrode terminal of a charger (not illustrated), respectively. On the other hand, when the battery pack 300 is discharged (when the electronic device 400 is in use), the positive electrode terminal 331a and the negative electrode terminal 331b of the battery pack 300 are connected to a positive electrode terminal and a negative electrode terminal of the electronic circuit 401, respectively.

Examples of the electronic device 400 include laptop personal computers, tablet computers, mobile phones (for example, smartphones), personal digital assistants (PDA), imaging devices (for example, digital still cameras, digital video cameras, and the like), audio devices (for example, portable audio players), game devices, cordless phones, electronic books, electronic dictionaries, radios, headphones, navigation systems, memory cards, pacemakers, hearing aids, lighting devices, toys, medical devices, robots, and other electronic devices, but the electronic device 400 is not limited thereto. As specific examples, a head-mounted display and a band type electronic device will be described. The head-mounted display is an electronic device that includes an image display device, a mounting device for mounting the image display device on the head of an observer, and an attachment member for attaching the image display device to the mounting device, and uses the battery of the first embodiment according to the present technology or the battery module of the second embodiment according to the present technology as a power source for driving. The band type electronic device includes a plurality of segments connected in a band form, a plurality of electronic components disposed in the plurality of segments, and a flexible circuit board that connects the plurality of electronic components in the plurality of segments and is disposed in a meandering shape in at least one segment, in which the battery of the first embodiment according to the present technology or the battery module of the second embodiment according to the present technology is disposed as the electronic components in the segments.

The electronic circuit 401 includes, for example, a CPU, a peripheral logic unit, an interface unit, a storage unit, and the like, and controls the entire electronic device 400.

The battery pack 300 includes an assembled battery 301 and a charge-discharge circuit 302. The assembled battery 301 is configured by connecting a plurality of batteries 301a in series and/or in parallel. The plurality of batteries 301a are connected, for example, n in parallel and m in series (n and m are positive integers). Note that FIG. 11 illustrates an example in which six batteries 301a are connected, two in parallel and three in series (2P3S). The battery according to the first embodiment may be used as the battery 301a, or the battery module according to the second embodiment may be used as the plurality of batteries 301a.

During charging, the charge-discharge circuit 302 controls charging of the assembled battery 301. On the other hand, during discharging (that is, when the electronic device 400 is in use), the charge-discharge circuit 302 controls discharging to the electronic device 400.

### EXAMPLES

Effects of the present technology will be specifically described below with reference to examples. Note that the scope of the present technology is not limited to the examples.

### Example 1

A battery cell-1 was produced including a battery element constituted of a wound electrode body obtained by winding a laminated body constituted of a positive electrode, a separator, and a negative electrode in 14 turns, an exterior body that covers the battery element, and a conductor that has a cut portion disposed between the battery element and the exterior body.

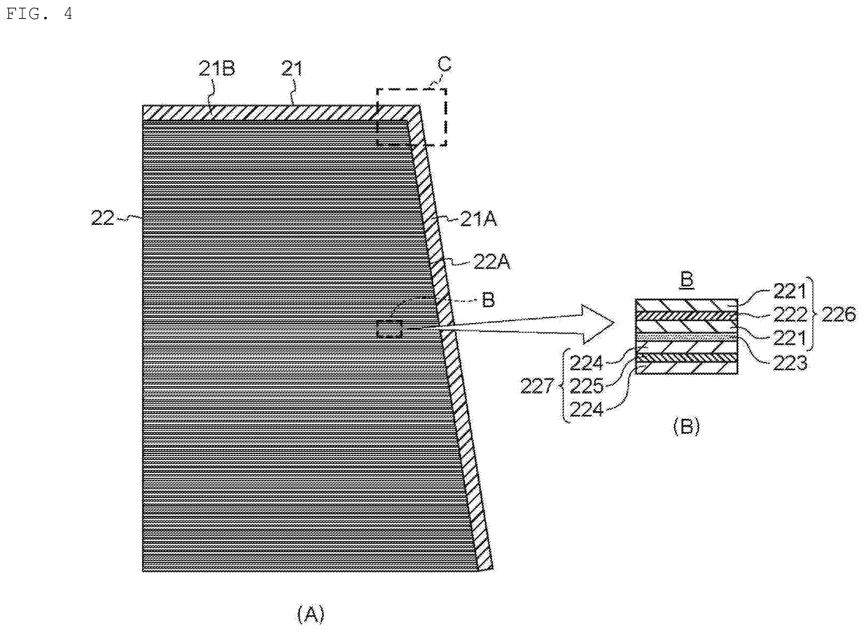

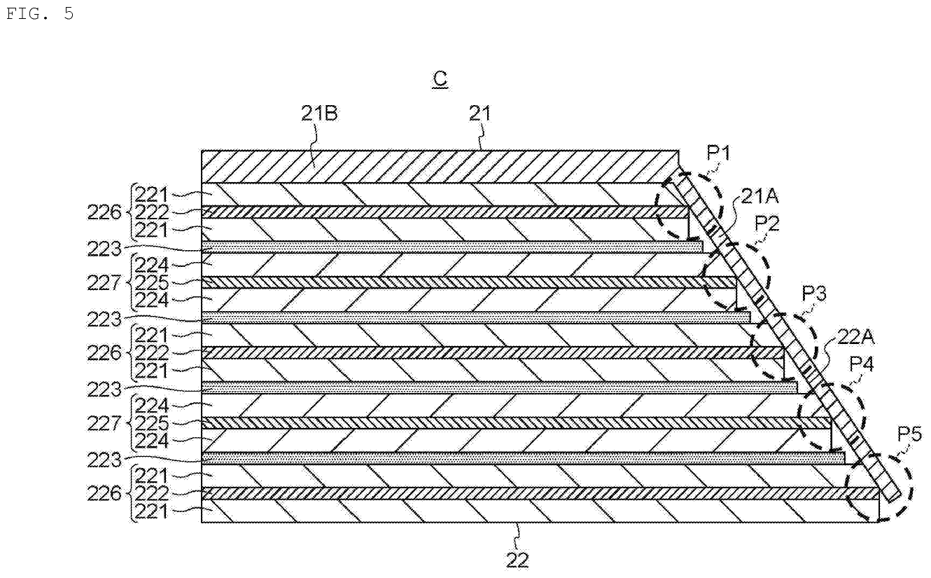

Subsequently, the produced battery cell-1 was damaged by an external force. FIG. 4(A) illustrates a schematic cross-sectional view of the battery cell-1 after breakage. FIG. 4(B) is an enlarged schematic cross-sectional view of a portion B illustrated in FIG. 4(A). FIG. 5 is an enlarged schematic cross-sectional view of a portion C illustrated in FIG. 4(A). As illustrated in FIG. 4(B) and FIG. 5, a battery element 22 included in the battery cell-1 has a configuration in which a negative electrode 227, a separator 223, and a positive electrode 226 are laminated in this order. Then, the positive electrode 226 has two positive electrode active material layers 221 and an Al foil (current collector foil) 222 disposed between the two positive electrode active material layers. The negative electrode 227 has two negative electrode active material layers 224 and a Cu foil (current collector foil) 225 disposed between the two negative electrode active material layers 224.

As illustrated in FIG. 4A, a short circuit occurs when a bent piece 21A of a cut portion of a damaged conductor 21 covers over a cross-sectional portion (a damaged portion of the battery element) 22A of the damaged battery element 22. More specifically, as illustrated in FIG. 5, in circular portions P1, P3, and P5, the bent piece 21A of the cut portion of the conductor 21 and the Al foil (current collector foil) 222 are in contact, and in circular portions P2 and P4, the bent piece 21A of the cut portion of the conductor 21 and the Cu foil (current collector foil) 225 are in contact, thereby causing a short circuit. As described above, by making contact at positions of a plurality of current collector foils, short-circuiting is easy and reliable, and safety is increased. Note that the bent piece 21A of the cut portion of the conductor 21 is produced, for example, by bending a cut portion 111-1 illustrated in FIG. 1 due to breakage, and (the length of) the bent piece 21A may correspond to (the length of) the straight portion 111B of the cut portion 111-1.

### Comparative Example 1

Next, a battery cell-A was produced including a battery element that has a wound electrode body obtained by winding a laminated body constituted of a positive electrode, a separator, and a negative electrode in 14 turns, and an exterior body that covers the battery element.

Subsequently, the battery cell-A produced in Comparative Example 1 was damaged by an external force.

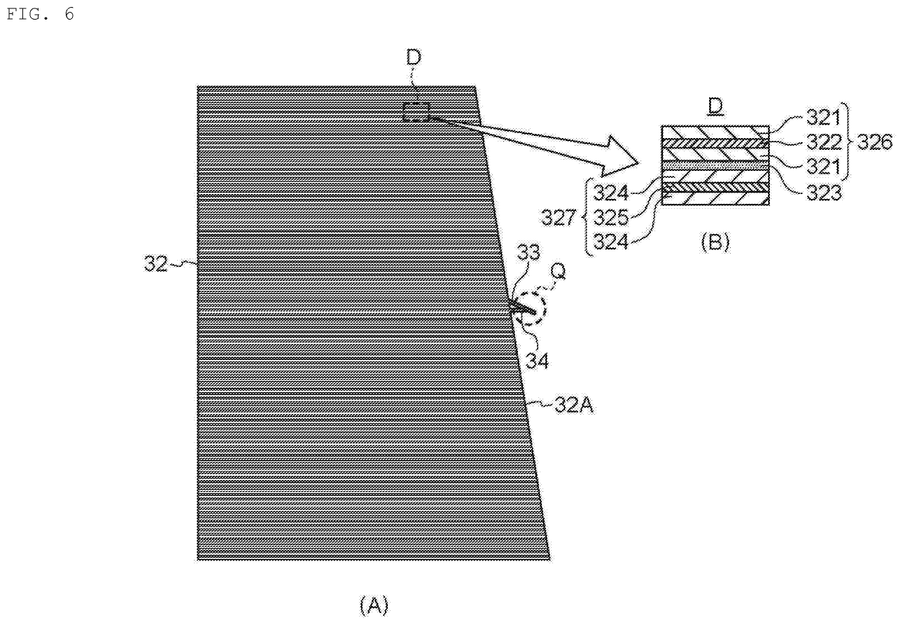

FIG. 6(A) illustrates a schematic cross-sectional view of the battery cell-A after breakage. FIG. 6(B) is an enlarged schematic cross-sectional view of a portion D illustrated in FIG. 6(A). As illustrated in FIG. 6(B), a battery element 32 included in the battery cell-A has a configuration in which a negative electrode 327, a separator 323, and a positive electrode 326 are laminated in this order. Then, the positive electrode 326 has two positive electrode active material layers 321 and an Al foil (current collector foil) 322 disposed between the two positive electrode active material layers 321. The negative electrode 327 has two negative electrode active material layers 324 and a Cu foil (current collector foil) 325 disposed between the two negative electrode active material layers 324.

As illustrated in FIG. 6(A), in a cross-sectional portion (a damaged portion of the battery element) 32A of the damaged battery element 32, as illustrated by a circular portion Q, an Al foil 33 and a Cu foil 34 are in contact and short-circuited at one position. Note that in FIG. 6 (A), the Al foil 33 and the Cu foil 34 are in contact and short-circuited, but the Al foil and the negative electrode active material layer or the Cu foil and positive electrode active material layer can be in contact and short-circuited.

### [Evaluation and Result of Maximum Heating Value of Battery Cell]

Maximum heating values of the damaged battery cell-1 and the damaged battery cell-A were calculated using a circuit simulator and compared. Results are illustrated in Table 1. As illustrated in Table 1, the maximum heating value of the battery cell-1 short-circuited by the conductor was 4.152 W, but the maximum heating value of the battery cell-A short-circuited between foils (Al foil and Cu foil) was 65.54 W. It was confirmed that the battery cell-1, which was short-circuited between a plurality of electrodes by the conductor, has a lower maximum heating value (W) and higher safety compared to the battery cell-A.

TABLE 1

| | | Battery cell-A |
|---|---|---|
| | Battery cell-1 | (Comparative |
| | (Example 1) | Example 1) |
| | Case where a short circuit | Case where a short |
| | occurred by a cut portion | circuit occurred at |
| | of a damaged conductor | one position by foils |
| | closely covering a cross | with each other inside |
| | section of the element | the damaged element |
| Maximum heating | 4.152 | 65.54 |
| value [W] of | | |
| battery cell | | |

Hereinafter, the present technology will be described more specifically with reference to Application Examples 1 to 5.

### Application Example 1: Printed Circuit Board

As illustrated in FIG. 12, the above-described battery or battery module can be mounted on a printed circuit board 1202 (hereinafter referred to as “PCB”) together with a charging circuit or the like. For example, on the PCB 1202, a battery or a battery module according to the present technology (in FIG. 12, a secondary battery 1203 is illustrated as a representative example of the battery and the battery module; the same applies below) and an electronic circuit such as a charging circuit can be mounted by a reflow process. A module in which the secondary battery 1203 and the electronic circuit such as a charging circuit are mounted on the PCB 1202 is referred to as a battery module 1201. The battery module 1201 has a card type configuration as necessary, and can be configured as a portable card type mobile battery.

On the PCB 1202, a charge control integrated circuit (IC) 1204, a battery protection IC 1205, and a remaining battery level monitoring IC 1206 are also formed. The battery protection IC 1205 controls a charging-discharging operation so that a charging voltage does not become excessive during charging or discharging, an overcurrent does not flow due to a load short circuit, and no overdischarging occurs.

A Universal Serial Bus (USB) interface 1207 is attached to the PCB 1202. The secondary battery 1203 is charged by electric power supplied through the USB interface 1207. In this case, the charging operation is controlled by the charging control IC 1204. Furthermore, predetermined electric power (for example, with a voltage of 4.2 V) is supplied to a load 1209 from load connection terminals 1208a and 1208b attached to the PCB 1202. The remaining battery level of the secondary battery 1203 is monitored by the remaining battery level monitoring IC 1206 in a manner that a display (not illustrated) indicating the remaining battery level is visible from the outside. Note that the USB interface 1207 may be used for load connection.

Specific examples of the load 1209 described above are as follows.

A. Wearable devices (sports watches, watches, hearing aids, and the like),

B. IoT devices (sensor network devices, and the like),

C. Amusement devices (portable game devices and game controllers),

D. IC board embedded batteries (real-time clock ICs),

E. Energy harvesting devices (storage elements for power generation elements of solar power generation, thermoelectric power generation, vibration power generation, and the like).

### Application Example 2: Universal Credit Card

Currently, many people carry multiple credit cards. However, there is a problem that the risk of loss, theft, and the like increases as the number of credit cards increases. Therefore, a card called a universal credit card in which functions such as a plurality of credit cards and point cards are integrated into one card has been brought into practical use. For example, information such as the numbers and expiration dates of various credit cards and point cards can be captured in this card, and thus having one such card in a wallet allows selecting and using a favorable card whenever it is desired.

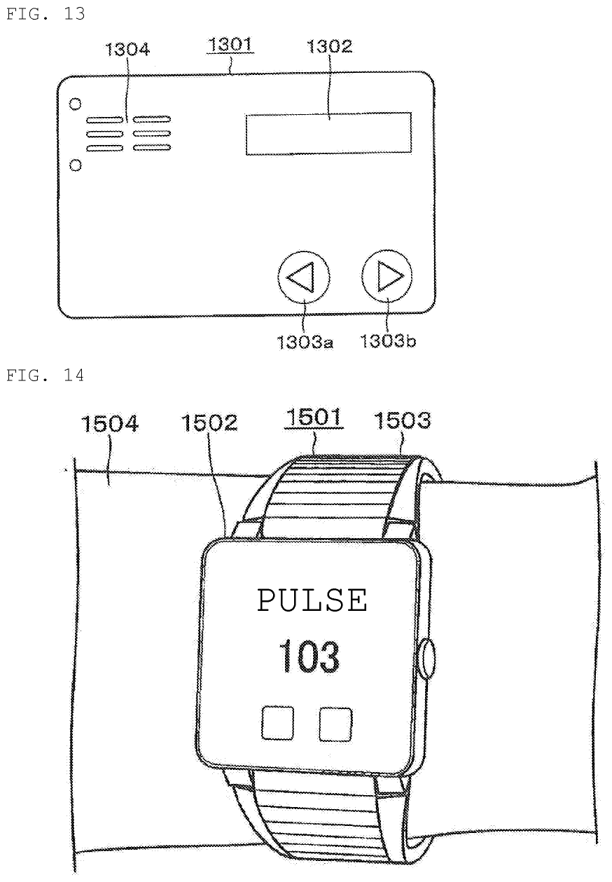

FIG. 13 illustrates an example of a configuration of a universal credit card 1301. The universal credit card has a card shape, and includes an IC chip and a battery or a battery module (not illustrated) according to the present technology. Furthermore, a display 1302, which consume less power, and an operating unit, for example direction keys 1303a and 1303b, are provided. Further, a charging terminal 1304 is provided on a surface of the universal credit card 1301.

For example, the user can specify a credit card or the like loaded in advance on the universal credit card 1301 by operating the direction keys 1303a and 1303b while looking at the display 1302. When a plurality of credit cards are loaded in advance, information indicating each credit card is displayed on the display 1302, and the user can specify a desired credit card by operating the direction keys 1303a and 1303b. Thereafter, the card can be used like a conventional credit card. Note that the above is an example, and it goes without saying that the battery or the battery module according to the present technology can be applied to any electronic card other than the universal credit card 1301.

### Application Example 3: Wristband Type Electronic Device

An example of a wearable terminal is a wristband type electronic device. Among others, a wristband type activity meter is also called a smart band, and can obtain data on human activities such as the number of steps, traveled distance, burned calories, sleep amount, heart rate, and the like just by being wrapped around the wrist. Further, the obtained data can also be managed with a smartphone. Furthermore, a mail transmission-reception function can be provided, and for example, one having a notification function that notifies the user of an incoming mail by a light emitting diode (LED) lamp and/or vibrations is used.

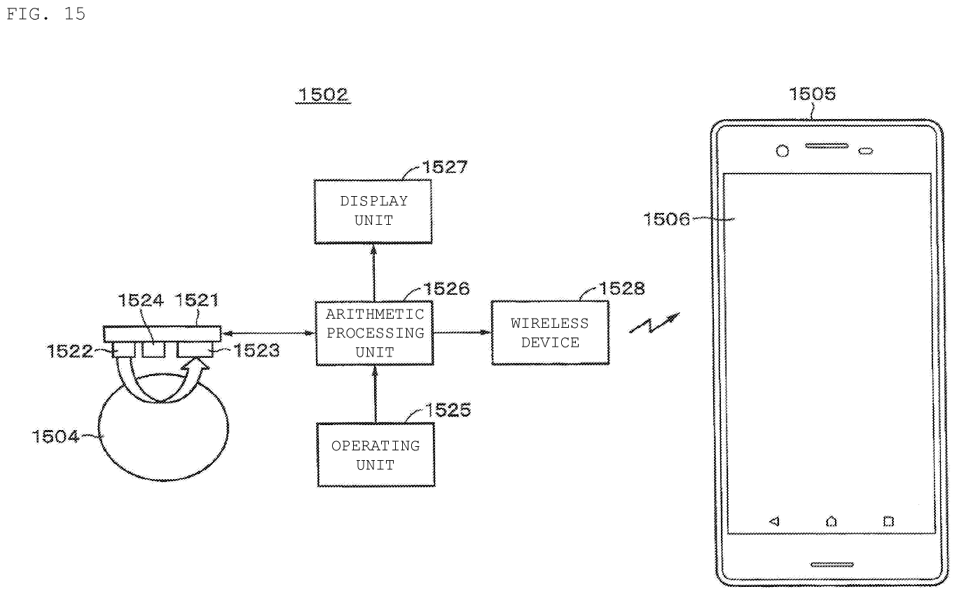

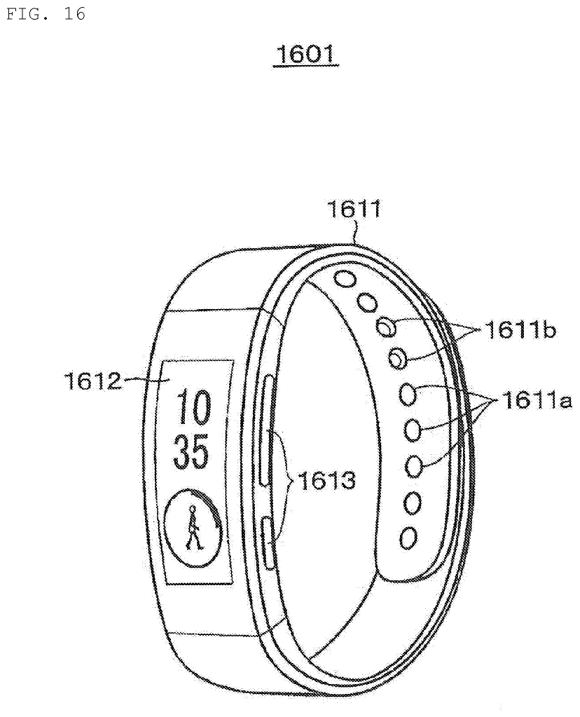

FIGS. 14 and 15 illustrate an example of a wristband type activity meter that measures, for example, a pulse. FIG. 14 illustrates a configuration example of an appearance of a wristband type activity meter 1501. FIG. 15 illustrates a configuration example of a main body 1502 of the wristband type activity meter 1501.

The wristband type activity meter 1501 is a wristband type measuring device that measures, for example, a pulse of a subject by an optical method. As illustrated in FIG. 14, the wristband type activity meter 1501 is constituted of a main body 1502 and a band 1503, and the band 1503 is attached to an arm (wrist) 1504 of a subject like a wristwatch. Then, the main body 1502 irradiates a portion including a pulse of the arm 1504 of the subject with measurement light having a predetermined wavelength, and measures the pulse of the subject based on intensity of returned light.

The main body 1502 is configured to include a substrate 1521, an LED 1522, a light receiving IC 1523, a light shield 1524, an operating unit 1525, an arithmetic processing unit 1526, a display unit 1527, and a wireless device 1528. The LED 1522, the light receiving IC 1523, and the light shield 1524 are provided on the substrate 1521. Under control of the light receiving IC 1523, the LED 1522 irradiates a portion including the pulse of the arm 1504 of the subject with measurement light having a predetermined wavelength.

The light receiving IC 1523 receives light that has returned after the arm 1504 is irradiated with the measurement light. The light receiving IC 1523 generates a digital measurement signal indicating intensity of the returned light, and supplies a generated measurement signal to the arithmetic processing unit 1526.

The light shield 1524 is provided between the LED 1522 and the light receiving IC 1523 on the substrate 1521. The light shield 1524 prevents the measurement light from the LED 1522 from being directly incident on the light receiving IC 1523.

The operating unit 1525 is constituted of various operating members such as buttons and switches for example, and is provided on a surface of the main body 1502 or the like. The operating unit 1525 is used to operate the wristband type activity meter 1501 and supplies a signal indicating an operation content to the arithmetic processing unit 1526.

The arithmetic processing unit 1526 performs an arithmetic process for measuring the pulse of the subject based on the measurement signal supplied from the light receiving IC 1523. The arithmetic processing unit 1526 supplies a measurement result of the pulse to the display unit 1527 and the wireless device 1528.

The display unit 1527 is constituted of a display device such as a liquid crystal display (LCD), and is provided on a surface of the main body 1502. The display unit 1527 displays the measurement result of the pulse of the subject and the like.

The wireless device 1528 transmits the measurement result of the pulse of the subject to an external device by wireless communication of a predetermined method. For example, as illustrated in FIG. 15, the wireless device 1528 transmits the measurement result of the pulse of the subject to a smartphone 1505, so as to display the measurement result on a screen 1506 of the smartphone 1505. Furthermore, data of measurement results are managed by the smartphone 1505, and the measurement results can be browsed with the smartphone 1505 or stored in a server on the network. Note that any method can be employed as a communication method of the wireless device 1528. Note that the light receiving IC 1523 can also be used for measuring a pulse in a part other than the arm 1504 (for example, a finger, an earlobe, or the like) of the subject.

The wristband type activity meter 1501 described above can accurately measure pulse waves and pulse of the subject by removing an influence of body movement by a signal process in the light receiving IC 1523. For example, even if the subject performs intense exercise such as running, the pulse waves and pulse of the subject can be accurately measured. Further, for example, even when the subject wears the wristband type activity meter 1501 for a long time and performs measurement, an influence of body movement of the subject can be removed and the pulse waves and pulse can be accurately measured.

Further, power consumption of the wristband type activity meter 1501 can be reduced by reducing the amount of calculation. As a result, for example, it is possible to perform measurement while the subject wears the wristband type activity meter 1501 for a long time without performing charging or battery replacement.

Note that, for example, a thin battery is housed in the band 1503 as a power source. The wristband type activity meter 1501 includes an electronic circuit of a main body and a battery pack. For example, the battery pack has a configuration to be detachable by the user. The electronic circuit is a circuit included in the main body 1502 described above. The present technology can be applied when a battery or a battery module is used as a power source.

FIG. 16 illustrates a configuration example of an appearance of a wristband type electronic device 1601 (hereinafter simply referred to as “electronic device 1601”).

The electronic device 1601 is, for example, what is called a wearable device of watch type that is detachable from a human body. The electronic device 1601 includes, for example, a band portion 1611 to be attached to an arm, a display device 1612 that displays numbers, characters, symbols, and the like, and an operating button 1613. The band portion 1611 is formed with a plurality of holes 1611a and protrusions 1611b formed on an inner peripheral surface (a surface that comes in contact with the arm when the electronic device 1601 is attached).

When in use, the electronic device 1601 is bent so that the band portion 1611 is substantially circular as illustrated in FIG. 16, and the protrusions 1611b are inserted into holes 1611a to be attached to the arm. By adjusting positions of the holes 1611a into which the protrusions 1611b are inserted, the size of the diameter can be adjusted corresponding to the thickness of the arm. When not in use, the electronic device 1601 is stored in a state that the protrusions 1611b are removed from the holes 1611a, and the band portion 1611 is substantially flat. The sensor according to an embodiment of the present technology is provided over the entire band portion 1611, for example.

### Application Example 4: Smart Watch

A smart watch has an identical or similar appearance to an existing wristwatch design, is worn on a wrist of a user and used similarly to a wristwatch, and has a function of notifying the user of various messages such as an incoming call or e-mail by information displayed on a display. Further, smart watches having functions such as an electronic money function and an activity meter have been proposed. In the smart watch, a display is incorporated in a surface of a main body portion of an electronic device, and various information is displayed on the display. Further, the smart watch can also cooperate with functions, contents, and the like of a communication terminal (such as a smart phone) by performing short-range wireless communication such as Bluetooth (registered trademark) with the communication terminal or the like.

As one of smart watches, there has been proposed one including a plurality of segments connected in a band form, a plurality of electronic components disposed in the plurality of segments, and a flexible circuit board that connects the plurality of electronic components in the plurality of segments and is disposed in a meandering shape in at least one segment. By having such a meandering shape, the flexible circuit board is not stressed even when the band is bent, and the circuit is prevented from being cut. Further, it is possible to incorporate electronic circuit components in a band-side segment attached to a watch body instead of a housing that constitutes the watch body, which eliminates the need to make changes on the watch body side and makes it possible to construct a smart watch having a similar design to conventional watches. In addition, the smart watch of this application example can perform a notification of an e-mail, an incoming call, or the like, log recording of user action history or the like, a telephone call, and the like. Further, the smart watch includes a function as a non-contact type IC card and can perform payment, authentication, or the like in a non-contact manner.

The smart watch of this application example incorporates circuit components for performing a communication process and a notification process in a metal band. In order to function as an electronic device while reducing the thickness of the metal band, the band has a configuration in which a plurality of segments are connected, and a circuit board, a vibration motor, a battery, and an acceleration sensor are accommodated in respective segments. Components such as a circuit board, a vibration motor, a battery, and an acceleration sensor in respective segments are connected by a flexible printed circuit board (FPC).

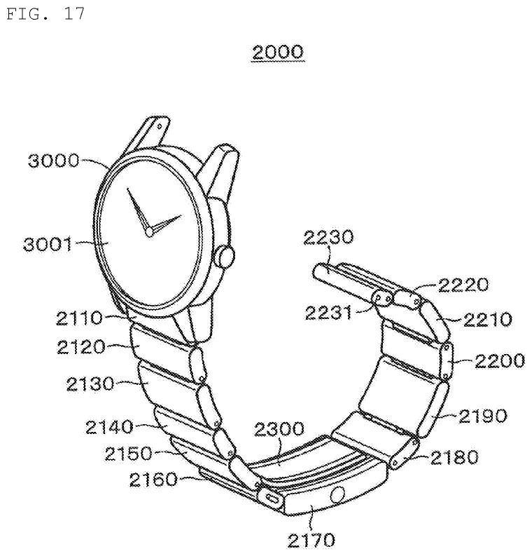

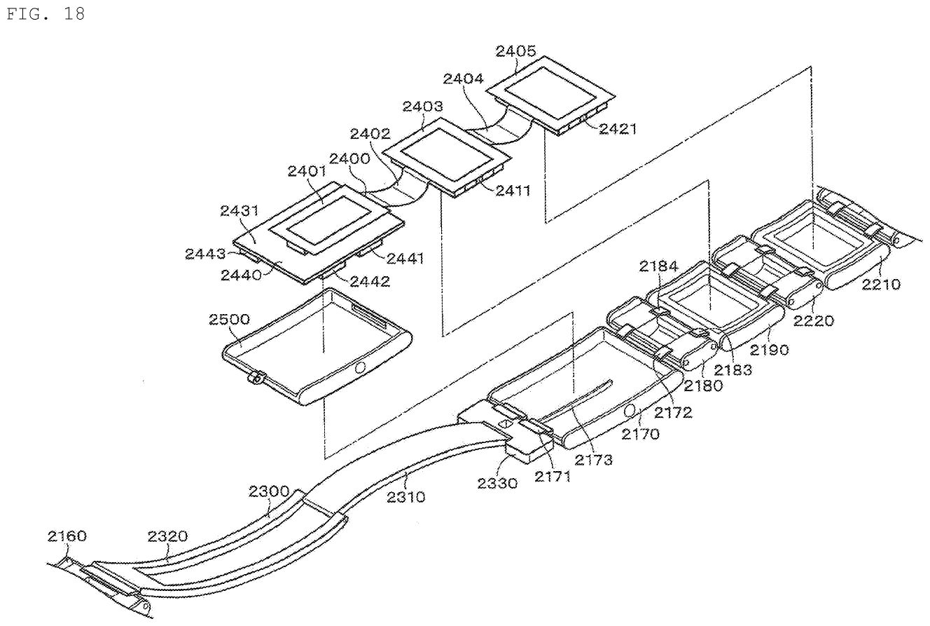

FIG. 17 illustrates an overall configuration (exploded perspective view) of the smart watch. The band type electronic device 2000 is a metal band attached to a watch main body 3000, and is attached to an arm of the user. The watch main body 3000 includes a dial 3100 that displays time. The watch main body 3000 may display the time electronically on a liquid crystal display or the like instead of the dial 3100.

The band type electronic device 2000 has a configuration in which a plurality of segments 2110 to 2230 are connected. The segment 2110 is attached to one band attachment hole of the watch main body 3000, and the segment 2230 is attached to the other band attachment hole of the watch main body 3000. In this example, each of the segments 2110 to 2230 is made of metal.

### (Internal Overview of Segment)

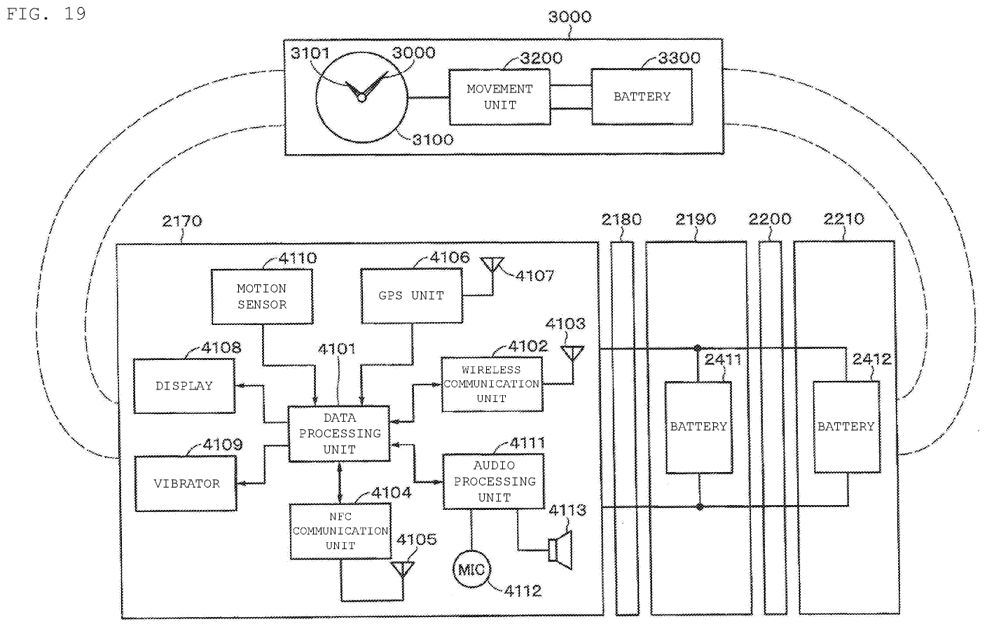

FIG. 18 illustrates a part of an internal configuration of the band type electronic device 2000. For example, insides of three segments 2170, 2180, 2190, 2200, 2210 are illustrated. In the band type electronic device 2000, a flexible circuit board 2400 is disposed inside five continuous segments 2170 to 2210. Various electronic components are disposed in the segment 2170, batteries 2411, 2421 which are batteries or battery modules according to the present technology are disposed in the segments 2190, 2210, and these components are electrically connected by the flexible circuit board 2400. The segment 2180 between the segment 2170 and the segment 2190 has a relatively small size, in which the flexible circuit board 2400 in a meandering state is disposed. Inside the segment 2180, the flexible circuit board 2400 is disposed in a state of being sandwiched between waterproofing members. Note that the insides of the segments 2170 to 2210 have a waterproof structure.

### (Smart Watch Circuit Configuration)

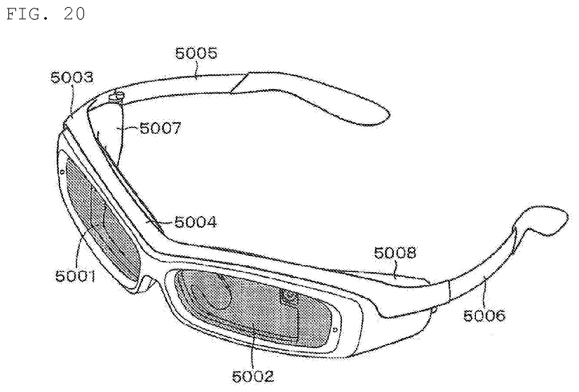

FIG. 19 is a block diagram illustrating a circuit configuration of the band type electronic device 2000. The circuit inside the band type electronic device 2000 has a configuration independent of the watch main body 3000. The watch main body 3000 includes a movement unit 3200 that rotates hands disposed on the dial 3100. A battery 3300 is connected to the movement unit 3200. The movement unit 3200 and the battery 3300 are incorporated in a housing of the watch main body 3000.

In the band type electronic device 2000 connected to the watch main body 3000, electronic components are disposed in the three segments 2170, 2190, 2210. In the segment 2170, a data processing unit 4101, a wireless communication unit 4102, an NFC communication unit 4104, and a GPS unit 4106 are disposed. Antennas 4103, 4105, 4107 are connected to the wireless communication unit 4102, the NFC communication unit 4104, and the GPS unit 4106, respectively. Each antenna 4103, 4105, 4107 is disposed in a vicinity of a slit 2173 which will be described later of the segment 2170.

The wireless communication unit 4102 performs short-range wireless communication with other terminals according to, for example, Bluetooth (registered trademark) standards. The NFC communication unit 4104 performs wireless communication with a nearby reader-writer according to the NFC standards. The GPS unit 4106 is a positioning unit that receives radio waves from satellites of a system called a global positioning system (GPS) and measures the current position. Data obtained by the wireless communication unit 4102, the NFC communication unit 4104, and the GPS unit 4106 is supplied to the data processing unit 4101.

Further, in the segment 2170, a display 4108, a vibrator 4109, a motion sensor 4110, and an audio processing unit 4111 are disposed. The display 4108 and the vibrator 4109 function as a notification unit that notifies the wearer of the band type electronic device 2000. The display 4108 is constituted of a plurality of light emitting diodes, and notifies the user by turning on or blinking light emitting diodes. The plurality of light emitting diodes are disposed, for example, in a slit 2173 which will be described later of the segment 2170, and an incoming call, reception of an e-mail, or the like is notified by lighting or blinking. As the display 4108, a display that displays characters, numbers, and the like may be used. A vibrator 4109 is a member that vibrates the segment 2170. The band type electronic device 2000 notifies an incoming call, reception of an e-mail, or the like by vibrations of the segment 2170 by the vibrator 4109.

The motion sensor 4110 detects movement of the user wearing the band type electronic device 2000. As the motion sensor 4110, an acceleration sensor, a gyro sensor, an electronic compass, an atmospheric pressure sensor, or the like is used. Further, the segment 2170 may incorporate a sensor other than the motion sensor 4110. For example, a biosensor that detects a pulse or the like of the user wearing the band type electronic device 2000 may be incorporated. A microphone 4112 and a speaker 4113 are connected to the audio processing unit 4111, and the audio processing unit 4111 performs a call process with the other party connected by wireless communication in the wireless communication unit 4102. Further, the audio processing unit 4111 can also perform a process for voice input operation.

The segment 2190 incorporates a battery 2411, and the segment 2210 incorporates a battery 2421. The batteries 2411, 2421 can be constituted of the battery or the battery module according to the present technology, and provides a power source for driving to the circuit in the segment 2170. The circuit in the segment 2170 and the batteries 2411, 2421 are connected by the flexible circuit board 2400 (FIG. 18). Note that although not illustrated in FIG. 19, the segment 2170 includes terminals for charging the batteries 2411, 2421. Further, electronic components other than the batteries 2411, 2421 may be disposed in the segments 2190, 2210. For example, the segments 2190, 2210 may include a circuit that controls charging and discharging of the batteries 2411, 2421.

### Application Example 5: Glasses Type Terminal

A glasses type terminal described below can display information such as texts, symbols, and images superimposed on a scenery in front. That is, a light-weight and thin image display device display module dedicated to a transmission glasses type terminal is mounted. A typical example is a head-mounted display (head mounted display (HMD)).

This image display device includes an optical engine and a hologram light guide plate. The optical engine emits image light of an image, a text, and the like using a micro display lens. This image light is incident on the hologram light guide plate. The hologram light guide plate includes hologram optical elements built into both ends of a transparent plate, and the image light from the optical engine is propagated through the very thin transparent plate with a thickness of 1 mm and delivered to the eyes of an observer. With such a configuration, a lens having a transmittance of, for example, 85% and a thickness of 3 mm (including protective plates before and after the light guide plate) is achieved. With such a glasses type terminal, it is possible to see results of players and teams in real time while watching sports, and to display a tourist guide at a travel destination.

In a specific example of the glasses type terminal, as illustrated in FIG. 20, the image display unit has a glasses type configuration. That is, similarly to normal glasses, a frame 5003 is provided for holding a right image display unit 5001 and a left image display unit 5002 in front of the eyes. The frame 5003 includes a front part 5004 disposed in front of the observer, and two temple parts 5005, 5006 rotatably attached to both ends of the front part 5004 with hinges interposed therebetween. The frame 5003 is made of the same material as that constituting normal glasses, such as metal, alloy, plastic, or a combination thereof. Note that a headphone unit may be provided.

The right image display unit 5001 and the left image display unit 5002 are disposed so as to be positioned in front of the right eye and in front of the left eye, respectively, of the user. The temple parts 5005, 5006 hold image display units 5001 and 5002 on the head of the user. A right display driving unit 5007 is disposed inside the temple part 5005 at a connection portion between the front part 5004 and the temple part 5005. A left display driving unit 5008 is disposed inside the temple part 5006 at a connection portion between the front part 5004 and the temple part 5006.

Although omitted in FIG. 20, in the frame 5003, the battery or the battery module according to the present technology, an acceleration sensor, a gyroscope, an electronic compass, a microphone-speaker, and the like are mounted. Furthermore, an image pickup device is attached, and a still image or a moving image can be taken. Moreover, a controller connected to a glasses part via, for example, a wireless or wired interface is provided. The controller is provided with a touch sensor, various buttons, a speaker, a microphone, and the like. Furthermore, the terminal has a function to cooperate with a smartphone. For example, it is possible to provide information according to the situation of the user by utilizing a GPS function of a smartphone.

The present technology is not limited to the above-described embodiments, examples, and application examples, and can be changed without departing from the gist of the present technology.

Note that the effects of the present technology should be obtainable without depending on the type of an electrode reactant if it is an electrode reactant used in a battery, and thus the same effects can be obtained even if the type of the electrode reactant is changed. In addition, chemical formulas of compounds and the like are representative and are not limited to the described valences and the like as long as they are of general names of the same compounds.

Further, the present technology can also take the following configurations.

[1]

A battery including a battery element, an exterior body that covers the battery element, and a conductor, in which

the conductor is disposed outside the battery element, and

the conductor has a cut portion.

[2]

The battery according to [1], in which the conductor is disposed inside the exterior body.

[3]

The battery according to [1] or [2], in which the cut portion penetrates therethrough.

[4]

The battery according to [1] or [2], in which the cut portion does not penetrate therethrough.

[5]

The battery according to any one of [1] to [4], in which the exterior body includes a laminate material.

[6]

A battery module including a plurality of batteries and a conductor, in which

each of the batteries includes a battery element and an exterior body that covers the battery element,

the conductor is disposed outside the battery element, and

the conductor has a cut portion.

[7]

The battery module according to [6], in which the conductor is disposed outside the exterior body.

[8]

The battery module according to [6] or [7], in which the cut portion penetrates therethrough.

[9]

The battery module according to [6] or [7], in which the cut portion does not penetrate therethrough.

[10]

The battery module according to any one of [6] to [9], in which the exterior body includes a laminate material.

[11]

A battery pack including the battery according to any one of [1] to [5].

[12]

A battery pack including:

the battery according to any one of [1] to [5];

a control unit that controls a use state of the battery; and

a switch unit that switches the use state of the battery according to an instruction from the control unit.

[13]

A vehicle including:

the battery according to any one of [1] to [5];

a driving force conversion apparatus that receives supply of electric power from the battery and converts the electric power into a driving force of the vehicle;

a driving unit that drives according to the driving force; and

a vehicle control device.

[14]

A power storage system including:

a power storage device that has the battery according to any one of [1] to [5];

a power consumption apparatus to which electric power is supplied from the battery;

a control device that controls power supply from the battery to the power consumption apparatus; and

a power generation apparatus that charges the battery.

[15]

A power tool including:

the battery according to any one of [1] to [5]; and

a movable part to which electric power is supplied from the battery.

[16]

An electronic device including the battery according to any one of [1] to [5], in which

the electronic device receives supply of electric power from the battery.

[17]

A vehicle including:

the battery module according to any one of [6] to [10],

a driving force conversion apparatus that receives supply of electric power from the battery module and converts the electric power into a driving force of the vehicle;

a driving unit that drives according to the driving force; and

a vehicle control device.

[18]

A power storage system including:

a power storage device that has the battery module according to any one of [6] to [10];

a power consumption apparatus to which electric power is supplied from the battery module;

a control device that controls power supply from the battery module to the power consumption apparatus; and

a power generation apparatus that charges the battery module.

[19]

An electronic device including the battery module according to any one of [6] to [10], in which

the electronic device receives supply of electric power from the battery module.

### DESCRIPTION OF REFERENCE SYMBOLS

1, 42, 44: Battery
4: Battery module
11, 13, 41, 43, 45: Conductor
12: Battery element
14: Exterior body
111-1, 111-2, 131-1, 131-2, 411-1, 411-2, 431-1, 431-2, 451-1, 451-2: Cut portion

1. A battery comprising:
a battery element;
an exterior body that covers the battery element; and
a conductor, wherein
the conductor is disposed outside the battery element, and
the conductor has a cut portion.

2. The battery according to claim 1, wherein the conductor is disposed inside the exterior body.

3. The battery according to claim 1, wherein the cut portion penetrates therethrough.

4. The battery according to claim 1, wherein the cut portion does not penetrate therethrough.

5. The battery according to claim 1, wherein the exterior body includes a laminate material.

6. A battery module comprising:
a plurality of batteries; and
a conductor, wherein
each of the batteries includes a battery element and an exterior body that covers the battery element,
the conductor is disposed outside the battery element, and
the conductor has a cut portion.

7. The battery module according to claim 6, wherein the conductor is disposed outside the exterior body.

8. The battery module according to claim 6, wherein the cut portion penetrates therethrough.

9. The battery module according to claim 6, wherein the cut portion does not penetrate therethrough.

10. The battery module according to claim 6, wherein the exterior body includes a laminate material.

11. A battery pack comprising the battery according to claim 1.

12. A battery pack comprising:
the battery according to claim 1;
a control unit that controls a use state of the battery; and
a switch unit that switches the use state of the battery according to an instruction from the control unit.

13. A vehicle comprising:
the battery according to claim 1;
a driving force conversion apparatus that receives supply of electric power from the battery and converts the electric power into a driving force of the vehicle;
a driving unit that drives according to the driving force; and
a vehicle control device.

14. A power storage system comprising:
a power storage device that has the battery according to claim 1;
a power consumption apparatus to which electric power is supplied from the battery;
a control device that controls power supply from the battery to the power consumption apparatus; and
a power generation apparatus that charges the battery.

15. A power tool comprising:
the battery according to claim 1; and
a movable part to which electric power is supplied from the battery.

16. An electronic device comprising the battery according to claim 1, wherein
the electronic device receives supply of electric power from the battery.

17. A vehicle comprising:
the battery module according to claim 6,
a driving force conversion apparatus that receives supply of electric power from the battery module and converts the electric power into a driving force of the vehicle;
a driving unit that drives according to the driving force; and
a vehicle control device.

18. A power storage system comprising:
a power storage device that has the battery module according to claim 6;
a power consumption apparatus to which electric power is supplied from the battery module;
a control device that controls power supply from the battery module to the power consumption apparatus; and
a power generation apparatus that charges the battery module.

19. An electronic device comprising the battery module according to claim 6, wherein
the electronic device receives supply of electric power from the battery module.
